(19) United States
(12) Patent Application Publication
(10) Pub. No.: US 2009/0231968 A1
(43) Pub. Date: Sep. 17, 2009

(54) RECORDING MEDIUM STORING MANAGEMENT INFORMATION FOR CONTENT ATTRIBUTE AND RECORDING DEVICE AND PLAYBACK DEVICE FOR THE RECORDING MEDIUM

(75) Inventors: Makoto Ochi, Osaka (JP); Kazuya Fujimura, Nara (JP); Shinji Inoue, Osaka (JP); Yasushi Nakajima, Osaka (JP); Tatsuya Suzuki, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/065,098

(22) PCT Filed: Aug. 29, 2006
(86) PCT No.: PCT/JP2006/316917

§ 371 Date: Feb. 28, 2008

(30) Foreign Application Priority Data
Aug. 31, 2005 (JP) 2005-251154

(51) Int. Cl. G11B 20/10; G11B 7/24

(52) U.S. Cl. 369/47.15; 369/275.3; G9B/7.139; G9B/20.009

(57) ABSTRACT

A semiconductor recording medium stores attribute management information for managing various attribute information on a content (genre, composer, artist, album, title, etc.) for each item; and sort management information managing information on a sort order when information managed by the attribute management information is sorted by a predetermined procedure. The attribute management information contains character data indicating items to be managed and pointer information indicating link relationship between the attribute management information. The sort management information contains information on the sort order when all the entries in each of attribute management information are sorted by a predetermined procedure for each of attribute management information.

### TECHNICAL FIELD

The present invention relates to a recording medium that records digital data content, and more particularly to a recording medium that stores management information on content attributes. In addition, the present invention relates to a device that reproduces content from such a recording medium and a device that records content in such a recording medium.

### BACKGROUND ART

For recording media that record various digital data (hereinafter, referred to as “content”) such as music content, moving image content, and still image content, there exist various types of media such as semiconductor recording media, magnetic disks, optical disks, and magneto-optical disks.

Among them, particularly, the semiconductor recording media have their features including small size and lightweight. Further, improvement of capacity and speed, and price reduction thereof have been rapidly achieved in recent years. Thus the semiconductor recording media can be used in various apparatuses such as digital cameras, mobile phones, portable music players, television sets, and DVD recorders. Typical semiconductor recording media include memory cards such as SD memory cards (registered trademark). Among these semiconductor recording media, there is a medium, as represented by an SD memory card, that has a copyright protection function and is capable of recording contents that require copyright protection.

An example of a content recording method that can be implemented by such a copyright protection function of a semiconductor recording medium is shown below.

A semiconductor recording medium has a protected area that can be accessed only when the semiconductor recording medium and a host device which is a playback device or a recording device have authorized each other, and a normal area that can be accessed without authorization. Encrypted content is recorded in the normal area, and a content key for encrypting the content is recorded in the protected area.

The content which is recorded in a semiconductor recording medium using such a copyright protection function cannot be reproduced by an unauthorized apparatus that cannot make mutual authorization with the semiconductor recording medium. In addition, just copying only the content recorded in the normal area to another memory card does not enable playback of the content because there is no content key. In this manner, it is possible to prevent illegal copy or the like of the content that requires copyright protection.

For a case of using the content, which requires copyright protection, there is a case in which a user rips content from a music CD bought by the user him/herself to a PC (personal computer) and records the ripped content in a semiconductor recording medium. Furthermore, there is a case in which content, such as music, a moving image, or a book, is downloaded from a content provider to a terminal, such as a PC or mobile phone, via the Internet or a mobile phone network by paying fee, the downloaded content is recorded in a semiconductor recording medium, and the content is reproduced using the semiconductor recording medium storing the content and a small semiconductor player. In addition, it is also possible to buy content not only through a PC or mobile phone connected to the Internet or a mobile phone network but also through an electronic terminal (KIOSK terminal) installed in specific places such as convenience stores, predetermined stores, and stations. Such expansion of a digital content distribution environment increases convenience for users and expands various sales networks for providers, and thus, it is expected that various content types and use environments continuously proliferate.

Meanwhile, upon recording content that requires copyright protection as described above in a semiconductor recording medium, recording standards as a recording method are determined according to characteristics of various semiconductor media and contents. Thus a recording device needs to record content in a semiconductor recording medium according to the recording standard. Accordingly, any apparatus can perform recording and playback as long as the apparatus complies with the recording standard.

For example, in an exemplary case of a music application, content corresponding to a song is encrypted with a content key and the encrypted content and the content key are recorded in a predetermined folder in a semiconductor recording medium in a predetermined file format. Patent Document 1 describes a semiconductor recording medium in which a plurality of encryption keys are recorded in a predetermined order to a protected area that can be accessed by successful authorization between the semiconductor recording medium and a host device, and the encrypted content and management information on the encrypted content are recorded in a normal area. The semiconductor recording medium achieves high convenience such as changing of the playback order of songs and capability of deleting a song, while preventing unauthorized decryption of music content.

Patent Document 1: JP-A-2001-249695

### DISCLOSURE OF INVENTION

### Problems to be Solved by the Invention

However, the above-described conventional art has the following problem. With an increase in the capacity of the semiconductor recording medium, the number of pieces of recordable content also increases. In order to obtain user's target content in a semiconductor recording medium having recorded therein many pieces of contents, an apparatus (e.g., a playback device) that installs the semiconductor recording medium needs to read and search all management information files related to all pieces of content recorded in the semiconductor recording medium. However, reading and searching all management information files by the apparatus for the user's target content while holding the management information files in the apparatus dramatically increases its overhead along with the increase in the number of pieces of content. This is a problem on practical use.

Particularly, when the maximum number of pieces of content to be managed which is specified according to the data recording standard for a semiconductor recording medium is very large, a process of reading management information files for all pieces of content and holding information in the management information files in the apparatus is an excessive load to an apparatus whose hardware performance is not relatively high, such as a playback-dedicated apparatus. Thus the apparatus cannot handle the process.

In view of the above-described problem, an object of the present invention is therefore to provide a recording medium having a mechanism that enables an apparatus having not so high hardware performance, such as a playback-dedicated apparatus, to easily perform a narrowing-down extraction of content, and a playback device and a recording device for such a recording medium.

### Means for Solving the Problems

In the present invention, in order that even an apparatus whose throughput is not so high, such as a playback-dedicated apparatus, can easily implement a narrowing-down search of content (particularly, audio content), attribute management files are provided for respective pieces of attribution information (genre, composer, artist, album, title, and so on) on the content. Furthermore, in order that while easily implementing an update of the attribute management files, sorted information in each attribute management file can be displayed, only sort information for the case in which information in each attribute management file is sorted is managed by a different file.

According to a first aspect of the present invention, there is provided a recording medium that records content. The recording medium includes plural pieces of attribute management information, each piece of attribute management information managing each of various pieces of attribute information on the content for each of various predetermined items, and sort management information that manages information on sort order when the information managed by the attribute management information is sorted by a predetermined procedure. The attribute management information includes text data indicating an item to be managed thereby, and pointer information indicating a link relationship between pieces of attribute management information. The sort management information includes, for each piece of attribute management information, information on a sort order when all entries in each piece of attribute management information are sorted by a predetermined procedure.

According to a second aspect of the present invention, there is provided a recording device that records content in a recording medium. The recording device includes an input unit that inputs content and pieces of various attribute information on the content, and a data recording unit that records the inputted content to the recording medium. The data recording unit generates pieces of attribute management information and sort management information based on the attribute information inputted from the input unit, each piece of attribute management information managing each of various pieces of attribute information on the content for each of various predetermined items, the sort management information managing information on sort order when the information managed by the attribute management information is sorted by a predetermined procedure. The data recording unit records the generated attribute management information and sort management information together with the content to the recording medium.

According to a third aspect of the present invention, there is provided a playback device that reproduces content recorded in a recording medium. The recording medium stores plural pieces of attribute management information, each piece of attribute management information managing each of various pieces of attribute information on the content for each of various predetermined items, and sort management information that manages information on sort order when the information managed by the attribute management information is sorted by a predetermined procedure. The attribute management information includes text data indicating an item to be managed thereby, and pointer information indicating a link relationship between pieces of attribute management information. The sort management information includes, for each piece of attribute management information, information on a sort order when all entries in each piece of attribute management information are sorted by a predetermined procedure.

The playback device includes a content reader. The content reader reads out the attribute management information and the sort management information from the recording medium, and identifies desired content data according to a user selection by referring to the read attribute management information and sort management information.

According to a fourth aspect of the present invention, there is provided a recording medium that stores a program for recording content in the recording medium. The program causes a computer to execute the procedures of: inputting content and pieces of various attribute information on the content; generating pieces of attribute management information and sort management information based on the inputted attribute information, each piece of attribute management information managing each of various pieces of attribute information on the content for each of various predetermined items, the sort management information managing information on sort order when the information managed by the attribute management information is sorted by a predetermined procedure; and recording the generated attribute management information and sort management information together with the content to a recording medium.

According to a fifth aspect of the present invention, there is provided a recording medium that stores a program for reproducing content from the recording medium. The recording medium stores plural pieces of attribute management information, each piece of attribute management information managing each of various pieces of attribute information on the content for each of various predetermined items, and sort management information that manages information on sort order when the information managed by the attribute management information is sorted by a predetermined procedure. The attribute management information includes text data indicating an item to be managed thereby, and pointer information indicating a link relationship between pieces of attribute management information. The sort management information includes, for each piece of attribute management information, information on a sort order when all entries in each piece of attribute management information are sorted by a predetermined procedure. The program causes a computer to execute the procedures of: reading out the attribute management information and the sort management information from the recording medium; sorting the information managed by each piece of attribute management information according to the sort management information, and displaying the sorted information on a selection screen; and identifying content to be reproduced, according to information selected by a user on the selection screen.

### EFFECTS OF THE INVENTION

According to the present invention, pieces of attribute management information that respectively manage attributes (genre, artist, composer, album, title, etc.) of content are hierarchically linked to one another, and information on the links (pointers) is managed by each piece of attribute management information. Hence a narrowing-down extraction of desired content can be performed with a simple configuration. In addition, sort management information that manages sort information on the pieces of attribute management information is separately provided. With this configuration, while suppressing an increase in complication of a process for updating the attribute management information, caused by content addition, content deletion, or the like, facilitation of a search based on the attributes of content recorded in a semiconductor recording medium is achieved.

### BRIEF DESCRIPTION OF DRAWINGS

FIG. 1 is a diagram showing a configuration of a semiconductor recording medium in a first embodiment of the present invention.

FIG. 2 is a diagram showing configurations of a search information recording area and a data area in the semiconductor recording medium.

FIG. 3 is a diagram describing encryption of content and content keys.

FIG. 4 is a diagram showing directory/file configurations in a recording medium of the first embodiment of the present invention.

FIG. 5 is a diagram showing a configuration of navigation files in the first embodiment of the present invention.

FIG. 6 shows diagrams showing examples of attribute information on audio content.

FIG. 7 is a diagram showing a configuration of a genre management file in the first embodiment of the present invention.

FIG. 8 is a diagram showing a configuration of a composer management file in the first embodiment of the present invention.

FIG. 9 is a diagram showing a configuration of an artist management file in the first embodiment of the present invention.

FIG. 10 is a diagram showing a configuration of an album management file in the first embodiment of the present invention (first example).

FIG. 11 is a diagram showing a configuration of a title management file in the first embodiment of the present invention.

FIG. 12 is a diagram showing a configuration of an album management file in the first embodiment of the present invention (second example).

FIG. 13 is a diagram showing a configuration of an album management file in the first embodiment of the present invention (third example).

FIG. 14 is a diagram showing configurations of a genre management file and a sort information management file in the first embodiment of the present invention (first example).

FIG. 15 is a diagram showing configurations of a genre management file and a sort information management file in the first embodiment of the present invention (second example).

FIG. 16 is a diagram showing a configuration of a recording device in the present invention.

FIG. 17 is a flowchart showing a recording process of the recording device in the first embodiment of the present invention.

FIG. 18 is a flowchart showing a navigation file generation method in the first embodiment of the present invention.

FIG. 19 is a diagram showing a configuration of a playback device in the first embodiment of the present invention.

FIG. 20 is a flowchart showing a process of the playback device in the first embodiment of the present invention.

FIGS. 21A and 21B are diagrams showing exemplary displays of selection menus on the playback device in the first embodiment of the present invention.

FIGS. 22C and 22D are diagrams showing exemplary displays of selection menus on the playback device in the first embodiment of the present invention.

FIG. 23 is a flowchart showing a process of the playback device when a selection is made by a user in an initial menu.

FIG. 24 is a flowchart showing a process of the playback device to be performed when a “genre list” is selected in the initial menu.

FIG. 25 is a flowchart showing a process of the playback device to be performed when a “composer (artist) list” is selected in the initial menu.

FIG. 26 is a flowchart showing a process of the playback device to be performed when an “album list” is selected in the initial menu.

FIG. 27 is a flowchart showing a process of the playback device to be performed when a “title list” is selected in the initial menu.

FIG. 28 is an illustrative diagram showing a configuration of navigation files in a second embodiment of the present invention.

FIG. 29 is a diagram showing a configuration of a genre management file in the second embodiment of the present invention.

FIG. 30 is a flowchart showing a process of the recording device in the second embodiment of the present invention.

FIG. 31 is a flowchart showing a process of the playback device in the second embodiment of the present invention.

FIG. 32 is an illustrative diagram showing a configuration of navigation files in a third embodiment of the present invention.

FIG. 33 is a diagram showing a configuration of a genre management file in the third embodiment of the present invention.

FIG. 34 is a flowchart showing a process when content is recorded in the third embodiment of the present invention.

FIG. 35 is a flowchart showing a process when content is deleted in the third embodiment of the present invention.

FIG. 36 is an illustrative diagram showing configurations of a title management file and a sort information management file in a fourth embodiment of the present invention.

FIG. 37 is a diagram showing an exemplary display of the playback device in the fourth embodiment of the present invention.

### DESCRIPTION OF REFERENCE NUMERALS

100 SEMICONDUCTOR RECORDING MEDIUM
110 HOST INTERFACE
120 CONTROLLER
130 RECORDING AREA
131 SPECIAL AREA
132 PROTECTED AREA
133 NORM AREA
201 and 201b COMPOSER MANAGEMENT FILE
203 and 203b ARTIST MANAGEMENT FILE
205 and 205b ALBUM MANAGEMENT FILE
207 TITLE MANAGEMENT FILE
209 SORT INFORMATION MANAGEMENT FILE
211 and 211b SORT INFORMATION MANAGEMENT FILE
1600 RECORDING DEVICE
1601 DATA RECORDING UNIT
1602 ENCODER
1603 ENCRYPTOR
1604 CONTENT KEY GENERATOR
1605 NAVIGATION FILE GENERATOR
1606 CONTENT INFORMATION GENERATOR
1607 DATA INPUT I/F UNIT
1608 CONTENT READER/WRITER
1609 CONTENT KEY READER/WRITER
1610 and 1808 MEDIUM ACCESS UNIT
1611 INPUT UNIT
1612 and 1909 DISPLAY UNIT
1800 PLAYBACK DEVICE
1801 OUTPUT UNIT
1802 CONTENT PLAYBACK UNIT
1803 ENCODER
1804 DECRYPTOR
1805 CONTENT KEY READER
1806 CONTENT READER
1807 CONTENT SEARCH UNIT

### BEST MODE FOR CARRYING OUT THE INVENTION

Embodiments of the present invention will be described below with reference to the accompanying drawings.

### First Embodiment

### 1. Semiconductor Recording Medium

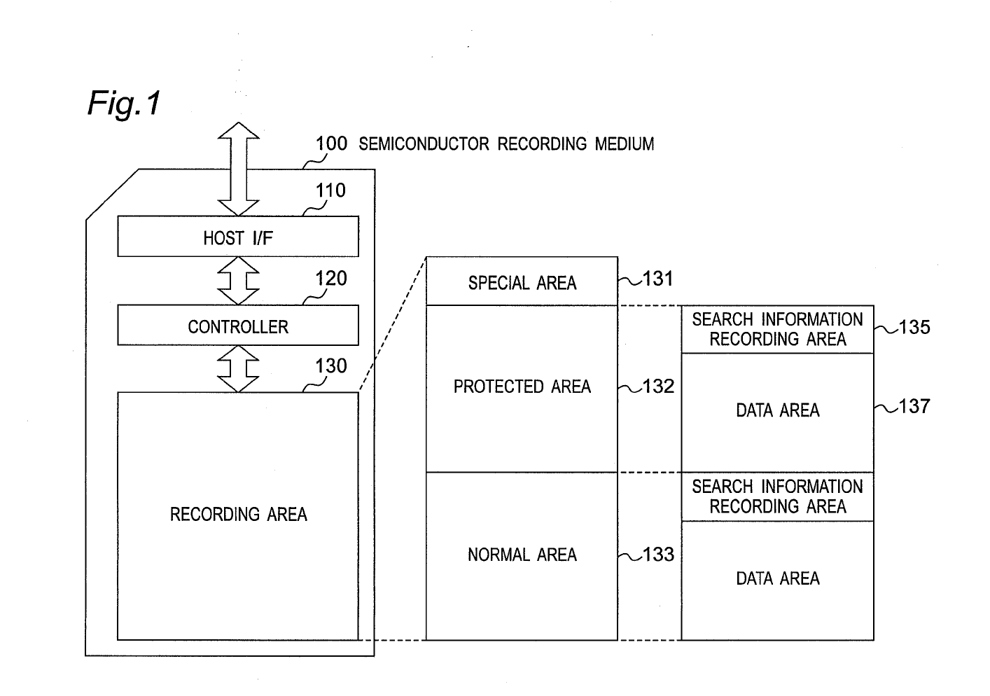

FIG. 1 is a diagram showing an example of the configuration of a semiconductor recording medium according to the embodiment of the present invention. A semiconductor recording medium 100 includes a host interface 110, a controller 120, and a recording area 130.

The host interface 110 has a function of transferring/receiving information to/from a host device (a playback device, a recording device, and so on) that accesses the semiconductor recording medium 100.

The controller 120 has a function of controlling the semiconductor recording medium 100. The controller 120 interprets a read or write command received from the host device and accesses the recording area 130. The controller 120 notifies the host device through the host interface 110, of the access result, if necessary.

The recording area 130 has a function of storing digital data and is physically composed of a non-volatile memory such as a flash memory. The recording area 130 has a special area 131, a protected area 132, and a normal area 133.

The special area 131 is an area having recorded therein digital data to be used therein by the semiconductor recording medium 100 and is an area that cannot be directly accessed by the host device. In the special area 131, upon manufacturing the semiconductor recording medium 100, a medium unique key which has a value specific to each semiconductor recording medium 100.

The protected area 132 is an area that can be accessed only when the host device and the semiconductor recording medium 100 successfully authorize each other. That is, only a host device that has succeeded in mutual authorization can read and write arbitrary digital data in the protected area 132.

The normal area 133 is an area from and to which the host device can read and write arbitrary digital data. That is, the normal area 133 is an area in which read and write can be performed without mutual authorization of the host device and the semiconductor recording medium 100.

Each of the protected area 132 and the normal area 133 includes a search information recording area 135 and a data area 137.

The data area 137 is an area for recording arbitrary digital data. The search information recording area 135 is an area for recording information (an address, a size, etc.) required when the host device takes out digital data recorded in the data area 137.

In the present embodiment, it is assumed that each digital data is managed by a FAT file system and information (file system management information) required by the FAT file system is recorded in a corresponding search information recording area 135.

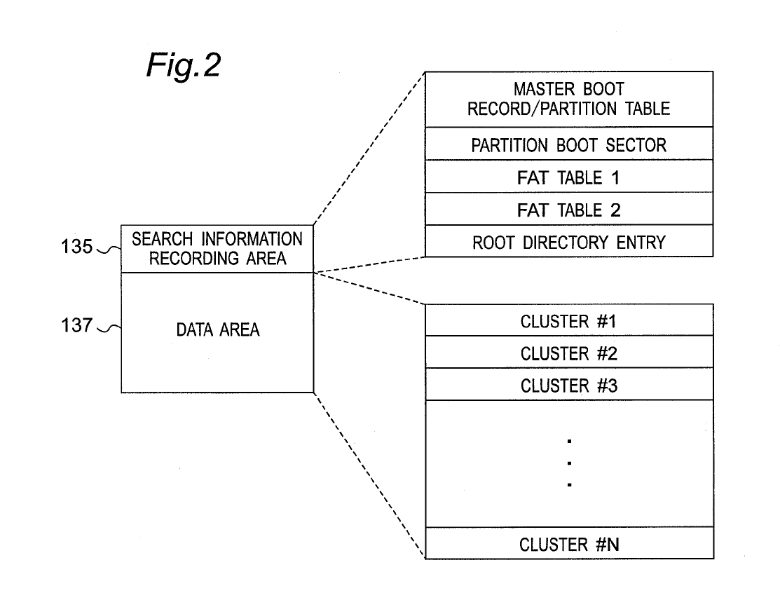

FIG. 2 shows exemplary configurations of the search information recording area 135 and the data area 137 for the case of adopting a FAT file system. In FIG. 2, the search information recording area 135 is composed of a master boot record partition table that records information for dividing the data area 137 into a plurality of areas called partitions and managing the partitions; a partition boot sector that records management information in one partition; a FAT table 1 and a FAT table 2 that show recording positions of data included in files; and a root directory entry that records information on a file and a directory present immediately under a root directory. The data area 137 is managed in a unit called a cluster. The details of the FAT file system is omitted.

### 1.1 Recording of Content to a Semiconductor Recording Medium

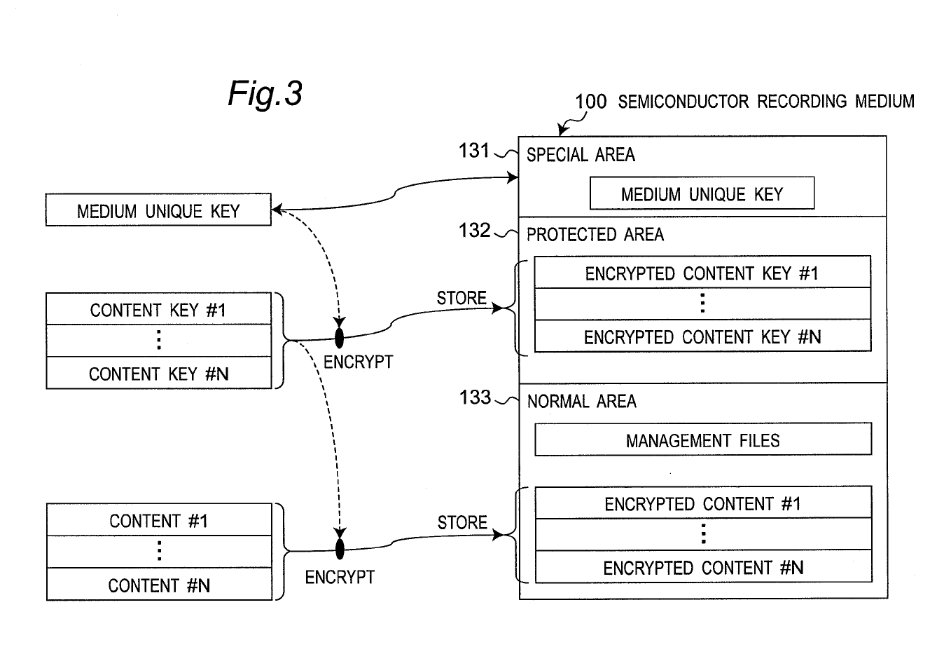

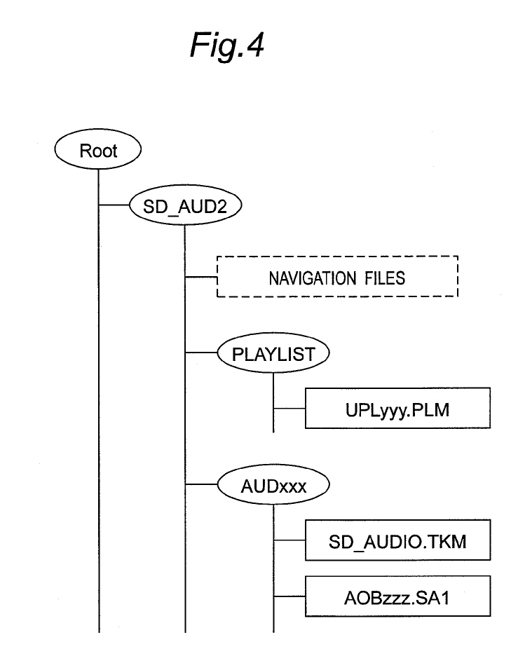

A method of recording content to the semiconductor recording medium 100 in the present embodiment will be described using FIGS. 3 and 4.

FIG. 3 is a diagram describing an example of the method of recording content in the semiconductor recording medium 100. The content is digital data, such as video data, music data, audio data, and text data, that is distributed via various networks such as the Internet and a mobile phone network, or recorded on a CD, an MD, a DVD, or the like, or recorded on an HDD of a PC as a file.

In FIG. 3, N pieces of content (content #1, . . . content #N) are respectively encrypted with N content keys (content key #1, . . . content key #N), whereby N pieces of encrypted content (encrypted content #1, . . . encrypted content #N) are generated. The pieces of encrypted content (encrypted content #1, . . . encrypted content #N) are recorded in the normal area 133 of the semiconductor recording medium 100, together with navigation files (the details of which will be described later) that manage attributes, and so on, of the content.

The N content keys (content key #1, . . . content key #N) are encrypted with a medium unique key recorded in the special area 131 of the semiconductor recording medium 100. The N encrypted content keys (content key #1, . . . content key #N) are recorded in the protected area 132 of the semiconductor recording medium 100 as a second-format encrypted content key #1, . . . a second-format encrypted content key #N.

FIG. 4 is a diagram specifically showing the data structure of directories and files of encrypted content data and management files which are recorded in the normal area 133 of the semiconductor recording medium 100. In the drawing, an oval block represents a directory and a rectangular block represents a file. A directory “SD_AUD2” is located immediately under a “Root” directory. “Navigation files” represented by a dashed line (the detail of which will be described later) are recorded immediately under the directory “SD_AUD2”. Furthermore, a directory “PLAYLIST” and a directory “AUDxxx” (xxx=001 to 999) are provided immediately under the directory “SD_AUD2”. In the directory “PLAYLIST”, a user playlist management file represented by “UPLyyy.PLM” (yyy=001 to 099) can be recorded. In the directory “AUDxxx”, a management file represented by “SD_AUDIO.TKM” and an encrypted content file (audio object) represented by “AOBzzz.SA1” (zzz=001 to 999) are recorded. Thus, 998,001 (=999×999) tracks can be recorded at most.

In FIG. 4, the navigation files include a plurality of files which are used for extracting content recorded in the semiconductor recording medium 100, and manage attribute information (meta-information) on various content in a consolidated manner. A detailed exemplary configuration will be described later.

The user playlist management file (UPLyyy.PLM) is a file for registering desired content selected by a user and can be accessed by a playback device that complies with a predetermined regulation (standard) such as in the present embodiment.

A management file represented by “SD_AUDIO.TK4” records information on a file “AOBzzz.SA1” which is content recorded in the same folder. The management file “SD_AUDIO.TKM” contains a codec, a time management table for a bit rate, a sampling frequency, and special playback, and text information.

The “AOBzzz.SA1” is audio content data. In the configuration in FIG. 4, various content, such as an image file and a text information file, that is associated with an audio content file may be further included.

As such, content to be recorded in the semiconductor recording medium 100 is recorded and managed together with various information by a recording device in predetermined folders and predetermined files, according to a predetermined regulation (standard). Therefore, an apparatus such as a playback device that complies with the regulation (standard) can read and reproduce data.

### 1.2 Navigation Files

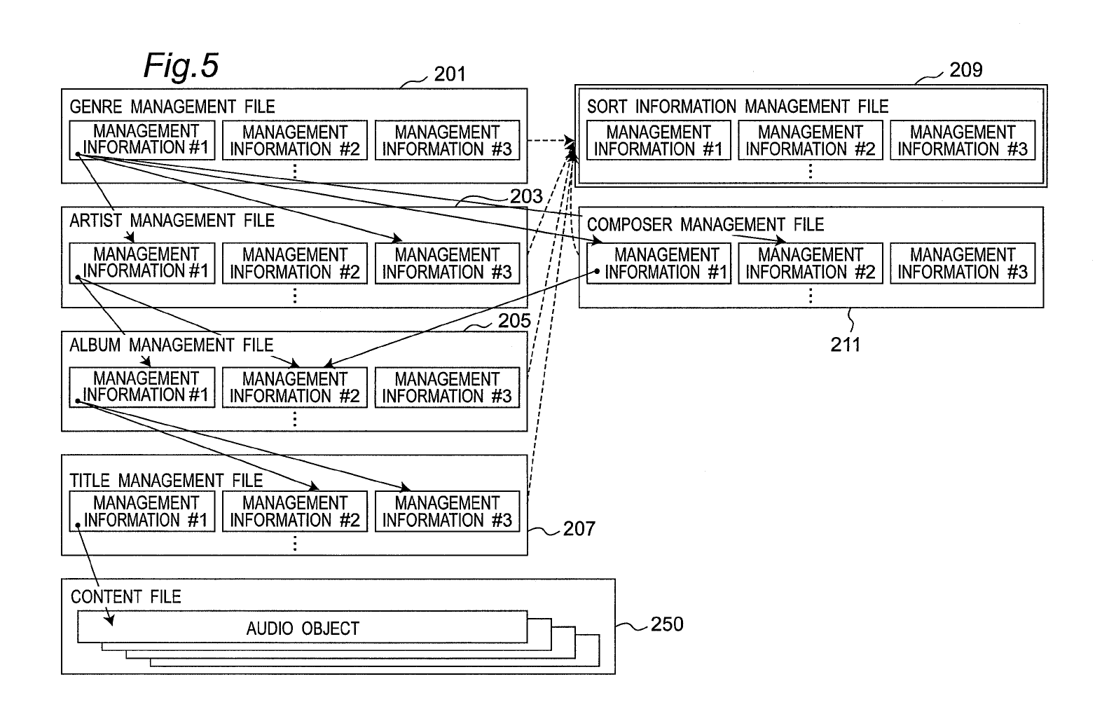

The navigation files will be described with reference to FIGS. 5 to 15. FIG. 5 is a diagram showing a relationship between the navigation files and a content file. A content file 250 contains audio objects.

The navigation files include various attribute management files 201, 203, . . . , each of which manages attribute information (genre, composer, artist, album, and title) on content for each item, and a sort information management file 209 that manages a sort order for the case in which information managed by an attribute management file is sorted by a predetermined procedure.

An attribute management file contains a plurality of pieces of management information (entries). Each attrite management file contains text information indicating the type of an attribute managed thereby, and information on pointers to other attribute management files. The attribute management files specifically include a genre management file 201, an artist management file 203, an album management file 205, a title management file 207, and a composer management file 211, and the sort information management file 209.

The genre management file 201 contains information required to manage audio content stored in the recording medium by genre (classical, jazz, pop, rock, and so on.). The artist management file 203 contains information required to manage audio content stored in the recording medium by artist. The album management file 205 contains information required to manage audio content stored in the recording medium by album. The title management file 207 contains information required to manage audio content stored in the recording medium by title (song title). The composer management file 211 contains information required to manage audio content stored in the recording medium by composer.

Each of the attribute management files including the genre management file 201, the artist management file 203, the album management file 205, the title management file 207, and the composer management file 211, contains a plurality of entries. Each entry (management information) includes text information and information on pointers to other attribute management files. More specifically, management information in the genre management file 201 includes the name of a genre and pointers to other attribute management files related to content belonging to the genre.

For example, in FIG. 5, the management information #1 contained in the genre management file 201 includes information on pointers to management information #1 and #3 in the artist management file 203 and pointers to management information #1 and #2 in the composer management file 211. Note that in FIG. 5 an arrow indicates a destination pointed by the pointer information.

Similarly, the management information in the artist management information file 203 includes information on pointers to the management information in the album management file 205. The management information in the album management file 205 includes information on pointers to the management information in the title management file 207. The management information in the title management file 207 includes information on a pointer relating to a recording location in the content 250 by which a content file can be identified.

As described above, the navigation files have a hierarchical structure in order of the genre management file 201→the artist management file 203→the composer management file 211→the album management file 205→the title management file 207, according to information accompanying the content.

The sort information management file 209 manages a state of management information (entry) that have been subjected to sorting in each of the attribute management files including the genre management file 201, the composer management file 211, the artist management file 203, the album management file 205, and the title management file 207. In FIG. 5, the dashed-line arrows indicate that information on a sorted state of management information in each of the attribute management files 201, 203 . . . , is recorded in the sort information management file. Thus, when management information in the genre management file 201 need to be obtained with the management information being sorted, it can be achieved by referring to sort information (management information) regarding the “genre management file” in the sort information management file 209.

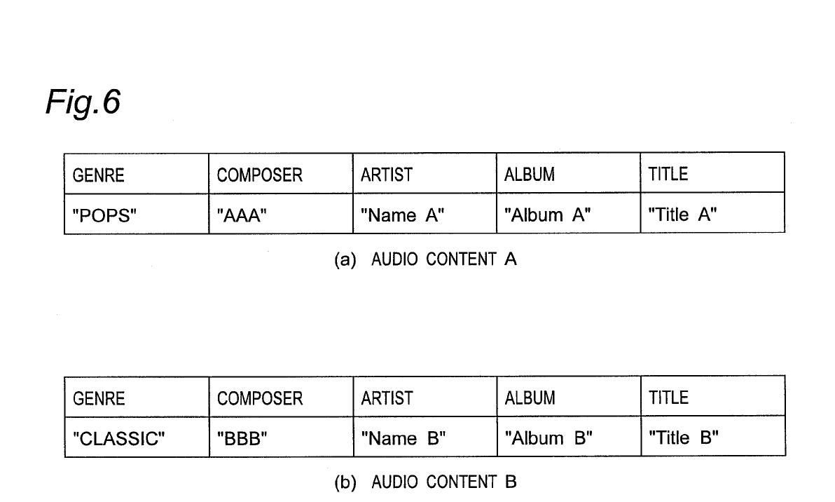

A further detailed exemplary configuration of the navigation files will be described. FIG. 6 is a diagram showing an example of information associated with audio content.

FIG. 6(a) shows an example of information associated with audio content A. The audio content A has accompanying information including “POPS (pop)” as genre information, “AAA” as composer information, “Name A” as artist information, “Album A” as album information, and “Title A” as title information. Audio content B shown in FIG. 6(b) has accompanying information including genre information “CLASSIC (classical)”, composer information “BBB”, artist information “Name B”, album information “Album B”, and title information “Title B”. Such accompanying information assigned to each content is available from a content holder (content provider) or WEB site for providing information via a network such as the Internet, or may be generated by a user.

### 1.2.1 Genre Management File

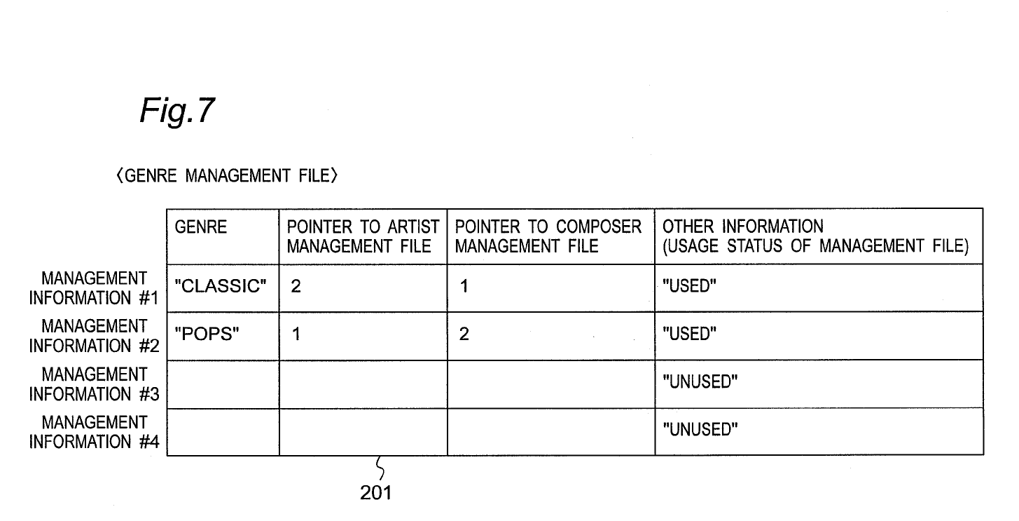

FIG. 7 is a diagram showing an example of recording of information to the genre management file 201 for the recording of the audio content shown in FIG. 6.

As shown in FIG. 7, each piece of management information in the genre management file 201 has 512 bytes length and includes text information indicating a genre name, a pointer to management information in the artist management file 203, a pointer to management information in the composer management file 211, and other information indicating the usage status of the management information.

The area of management information #2 which is the second entry is used for the audio content A shown in FIG. 6(a) and the genre name “POPS” is recorded as text information. In addition, in the management information #2, “1” is recorded as a pointer to the artist management file 203. This indicates that information on an artist of the audio content A belongs to the first entry, i.e., management information #1, in the artist management file 203. Similarly, “2” is recorded as a pointer to the composer management file 211. This indicates that information on a composer of the audio content A belongs to management information #2 which is the second entry in the composer management file 211. Information “used” indicating the usage status of the second entry is recorded in the “other information”.

The same also applies to the audio content B shown in FIG. 6(b). “CLASSIC” as text information, “2” as a pointer to the artist management file 203, “1” as a pointer to the composer management file 211, and information “used” as other information are recorded in management information #1.

Note that in the example of FIG. 7 management information #3 and management information #4 are not used and thus “unused” is recorded as other information. Namely, FIG. 7 indicates that although an area for recording information itself is reserved, it is not yet used as management information. There are no particular limitations as to which management information (entry) is used for content, in the attribute management file.

### 1.2.2 Composer Management File

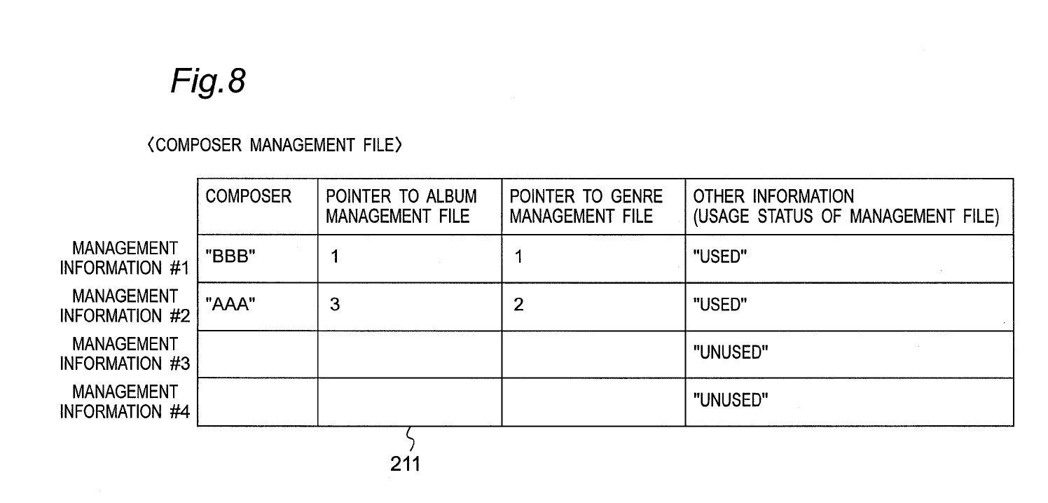

FIG. 8 shows exemplary recording of information in the composer management file 211 for the audio content shown in FIG. 6. Each piece of management information in the composer management file 211 includes text information indicating a composer name, a pointer to the album management file 205, a pointer to the genre management file 201, and the other information, having a total of 512 bytes length.

Composer information of the audio content A shown in FIG. 6(a) is “AAA” and “2” as a pointer to the composer management file is recorded in the management information #2 of the genre management file 201 shown in FIG. 7. Thus, “AAA” is recorded as text information in the area of management information #2 which is the second entry of management information in the composer management file 211. “3” as a pointer to the album management file 205 is recorded in the management information #2. This indicates that album information of the audio content A belongs to management information #3 in the album management file 205. In addition, “2” is recorded as a pointer to the genre management file 201, which indicates that genre information of the audio content A belongs to management information #2 which is the second management information in the genre information management file 201. In addition, information “used” indicating the usage state of the entry is recorded as other information.

The same also applies to the audio content B shown in FIG. 6(b). Composer information of the audio content B is “BBB”, and “1” as a pointer to the composer management file 211 is recorded in the management information #1 in the genre management file 201 shown in FIG. 7. Thus, in the area of management information #1 which is the first entry in the composer management file 211, “BBB” is recorded as its composer's name (text information), “1” is recorded as a pointer to the album management file 205, “1” is recorded as a pointer to the genre management file 201, and “used” is recorded as other information.

In management information #3 and management information #4, information “unused” is recorded as other information, which indicates that although an area for recording information itself is reserved, it is not used as management information.

### 1.2.3 Artist Management File

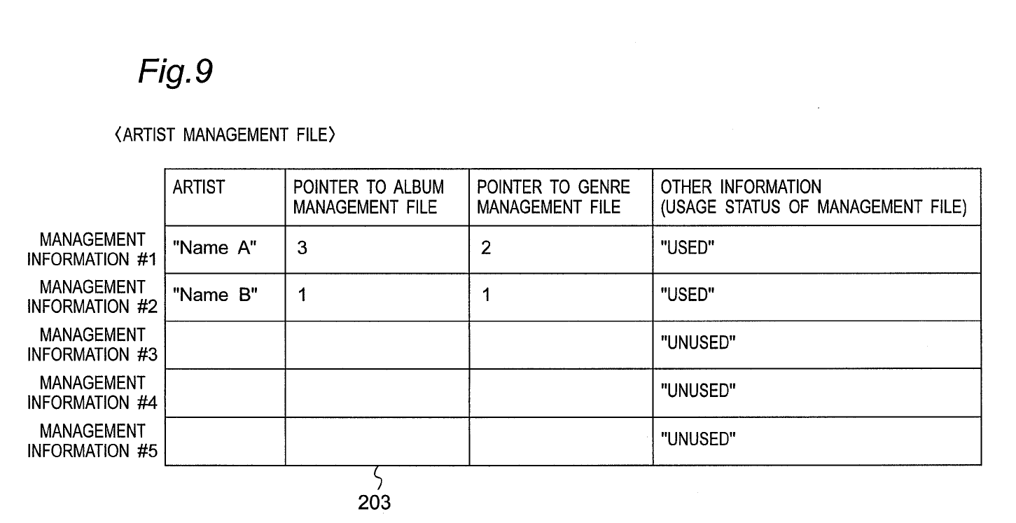

FIG. 9 shows exemplary recording of information in the artist management file 203 for the audio content shown in FIG. 6. Each piece of management information in the artist management file 203 includes text information indicating an artist name, a pointer to the album management file 205, a pointer to the genre management file 201, and other information, having a total of 512 bytes length.

Artist information of the audio content A shown in FIG. 6(a) is “Name A”, and “1” as a pointer to the artist management file 203 is recorded in the management information #2 in the genre management file 201 shown in FIG. 7. Thus, “Name A” is recorded as text information in the area of management information #1 which is the first entry of management information in the artist management file 203. In the management information #1, “3” is recorded as a pointer to the album management file 205. This indicates that album information of the audio content A belongs to management information #3 in the album management file 205. In addition, “2” is recorded as a pointer to the genre management file 201. This indicates that genre information of the audio content A belongs to the management information #2 which is the second management information in the genre information management file 201. In addition, “used” indicating the usage status of the entry is recorded as other information.

The same also applies to the audio content B shown in FIG. 6(b). Artist information of the audio content B is “Name B”, and “1” is recorded as a pointer to the composer management file 211 in the management information #1 in the genre management file 201 shown in FIG. 7. Thus, in the area of management information #1 which is the first entry of management information in the artist management file 203, “Name B” is recorded as its artist's name (text information), “1” is recorded as a pointer to the album management file 205, “1” is recorded as a pointer to the genre management file 201, and “used” is recorded as other information.

In management information #3, “unused” is recorded as other information, which indicates that although an area for recording information itself is reserved, it is not used as management information.

### 1.2.4 Album Management File

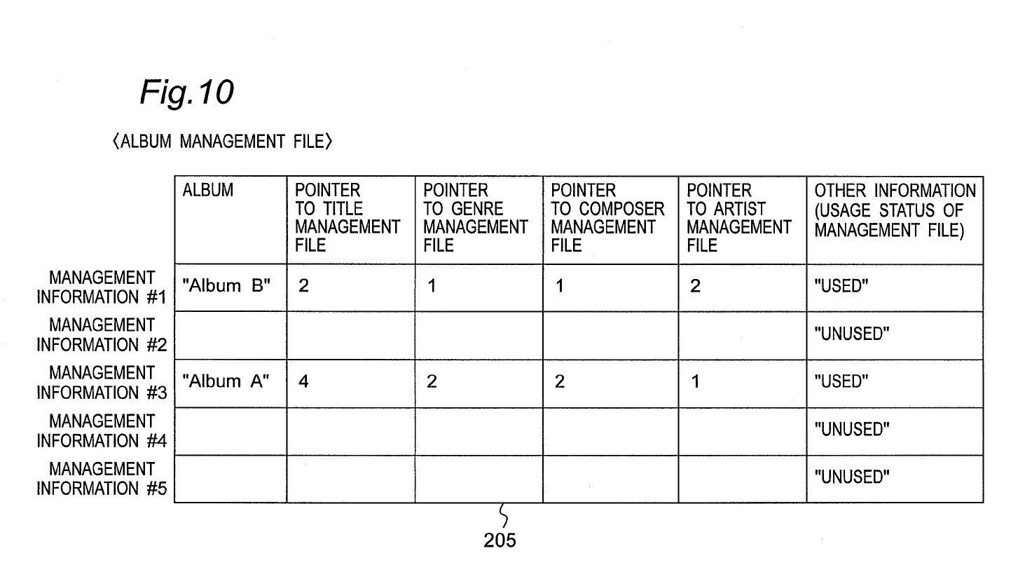

FIG. 10 shows exemplary recording of information in the album management file 205 for the audio content shown in FIG. 6. Each piece of management information in the album management file 205 includes text information indicating an album name, a pointer to the title management file 207, a pointer to the genre management file 201, a pointer to the artist management file 203, a pointer to the composer management file 211, and other information, having a total of 512 bytes length.

Album information of the audio content A shown in FIG. 6(a) is “Album A”, and “3” as a pointer to the album management file 205 is recorded in the management information #1 in the artist management file 203 shown in FIG. 9. Thus, in the area of management information #3 which is the third entry of management information in the album management file 205, “Album A” is recorded as an album name (text information). In the management information #3, “4” is recorded as a pointer to the title management file 207. This indicates that a title of the audio content A belongs to management information #4 in the title management file 207. In addition, “2” is recorded as a pointer to the genre management file 201. This indicates that genre information of the audio content A belongs to the management information #2 which is the second management information in the genre management file 201. In addition, “2” is recorded as a pointer to the composer management file 211. This indicates that composer information of the audio content A belongs to the management information #2 which is the second management information in the composer management file 211. “1” is recorded as a pointer to the artist management file 203. This indicates that artist information of the audio content A belongs to the management information #1 which is the first management information in the artist management file 203. In addition, “used” indicating the usage status of the entry is recorded as other information.

The same also applies to the audio content B shown in FIG. 6(b). Album information of the audio content B is “Album B”, and “1” is recorded as a pointer to the album management file 205 in the management information #2 in the artist management file 203 shown in FIG. 9. Thus, in the area of management information #1 which is the first entry of management information in the album management file 205, “Album B” is recorded as an album name (text information), “2” is recorded as a pointer to the title management file 207, “1” is recorded as a pointer to the genre management file 201, “1” is recorded as a pointer to the composer management file 211, “2” is recorded as a pointer to the artist management file 203, and “used” is recorded as other information.

In management information #2, management information #4, and management information #5, information “unused” is recorded as other information, which indicates that although an area for recording information itself is reserved, it is not used as management information.

### 1.2.5 Title Management File

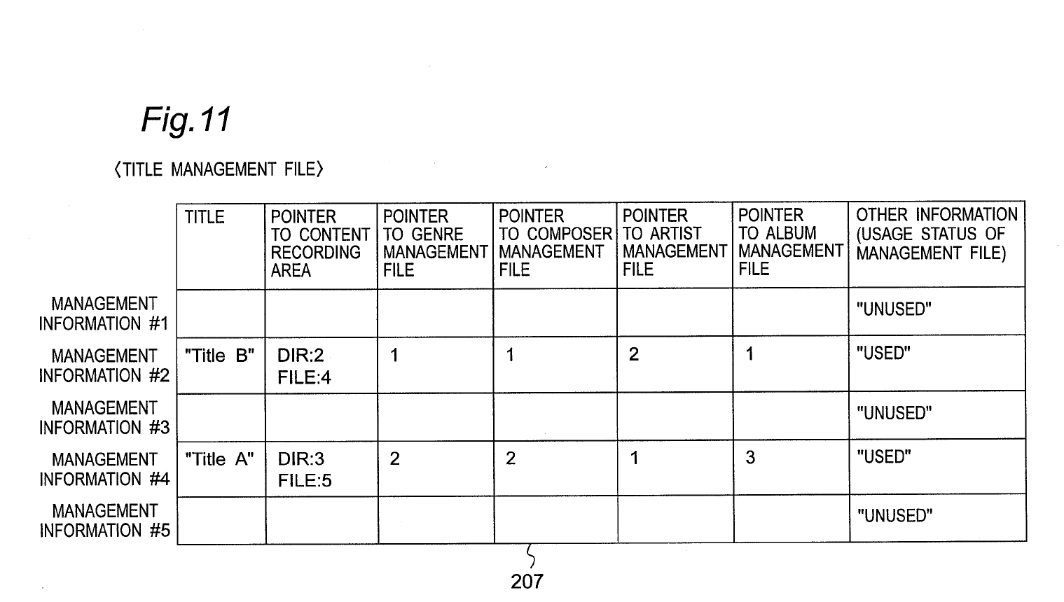

FIG. 11 shows exemplary recording of information in the title management file 207 for the audio content shown in FIG. 6. Each piece of management information in the title management file 207 includes text information indicating a title, a pointer to a content recording location, a pointer to the genre management file 201, a pointer to the composer management file 211, a pointer to the artist management file 203, a pointer to the album management file 205, and other information, having a total of 512 bytes length.

Title information of the audio content A shown in FIG. 6(A) is “Title A”, and “4” as a pointer to the title management file is recorded in the management information #3 in the album management file 205 shown in FIG. 10. Thus, in the area of management information #4 which is the fourth entry of management information in the title management file 207, “Title A” is recorded as a title (text information). “DIR:3 and FILE:5” is recorded as a pointer to a content recording location. This indicates that the audio content A is a file “AOB005.SA1” in a directory “AUD003”. “2” is recorded as a pointer to the genre management file 201. This indicates that a genre of the audio content A belongs to the management information #2 which is the second management information in the genre management file 201. “2” is recorded as a pointer to the composer management file 211. This indicates that composer information of the audio content A belongs to the management information #2 which is the second management information in the composer management file 211. “1” is recorded as a pointer to the artist management file 203. This indicates that artist information of the audio content A belongs to the management information #1 in the artist management file 203. “3” is recorded as a pointer to the album management file 205. This indicates that album information of the audio content A belongs to the management information #3 in the album management file 205. In addition, “used” indicating the usage status of the entry is recorded as other information.

The same also applies to the audio content B shown in FIG. 6(B). Title information of the audio content B is “Title B” and “2” is recorded as a pointer to the title management file 207 in the management information #1 in the album management file 205 shown in FIG. 10. Thus, in the area of management information #2 which is the second entry in the title management file 207, “Title B” is recorded as a title (text information), “DIR:2 and FILE:4” are recorded as a pointer to a content recording location, “1” is recorded as a pointer to the genre management file 201, “1” is recorded as a pointer to the composer management file 211, “2” is recorded as a pointer to the artist management file 203, “1” is recorded as a pointer to the album management file 205, and “used” is recorded as other information. In management information #1, management information #3, and management information #5, information “unused” is recorded as other information, which indicates that although an area for recording information itself is reserved, it is not used as management information.

The configuration of each attribute management file as described above is described with reference to the content shown in FIG. 6. When in each attribute management file new management information needs to be added upon recording new content, for example, management information (entry) can be added. Hence, the size of each attribute management file is a variable length. On the other hand, when management information becomes unnecessary with the deletion of content, it can be handled by changing a flag in the other information indicating a usage status to “unused”, for example, without deleting the area of the management information (entry). The above example shows that the flag indicating a usage status is held in individual management information. Instead of it, as an example, an area for managing integrally the entire usage status of the file is provided at a head portion of one piece of management file, or the entire usage status may be managed using another file.

Note that a single type of text information is shown as text information in each attribute management file. However a plurality of pieces of text information may be recorded in the same management information, so that character codes of different types can be simultaneously handled and the text information is not limited to that described above. For example, it may be configured that a plurality of areas, each capable of storing text information, are provided in each piece of management information and a dedicated area determined according to a character code such as a 1-byte character code or a 2-byte character code is used.

For simplicity of description, the case in which there is only one pointer in each of the genre management file 201, the composer management file 211, the artist management file 203, and the album management file 205 is described as an example. However, it may be configured, as shown in FIG. 5, that individual management information can store a plurality of pointers and can record pointers to management information in a plurality of attribute management files. In such a case, pointers to be recorded in one piece of management information may be recorded in a predetermined sequence. Further, in such a case, when the number of pointers which need to be recorded is more than the number of pieces of management information which can be recorded in one entry, the pointers to management information may be recorded by using a plurality of entries with link information.

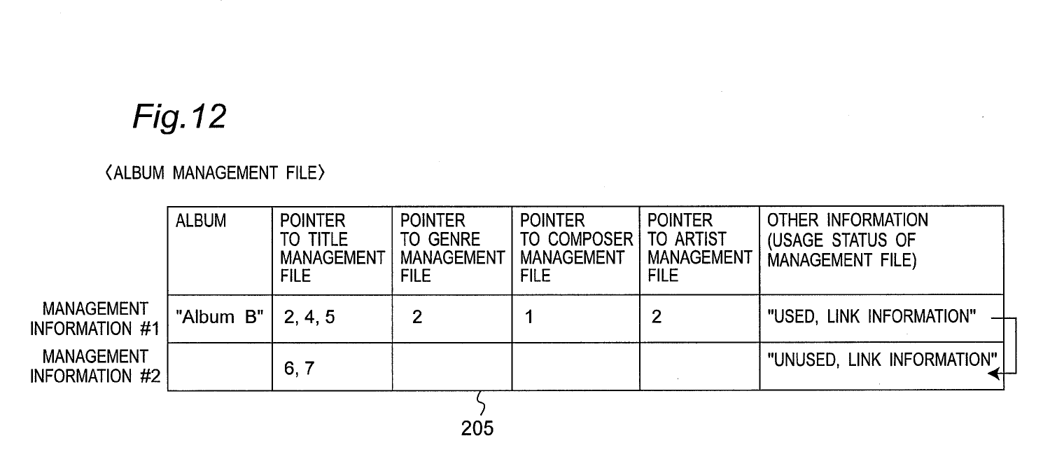

FIG. 12 is a diagram showing an exemplary configuration in which a large number of pointers are managed by using a plurality of pieces of management information (entries). In the drawing, it is assumed that three pointers to the title management file 207 can be registered in one piece of management information in the album management file 205 at most. When it needs to record three or more of pointers to the title management file 207 for the “Album B”, link information is recorded in the “other information”, so that management information #1 and management information #2 can be used as management information of the “Album B”.

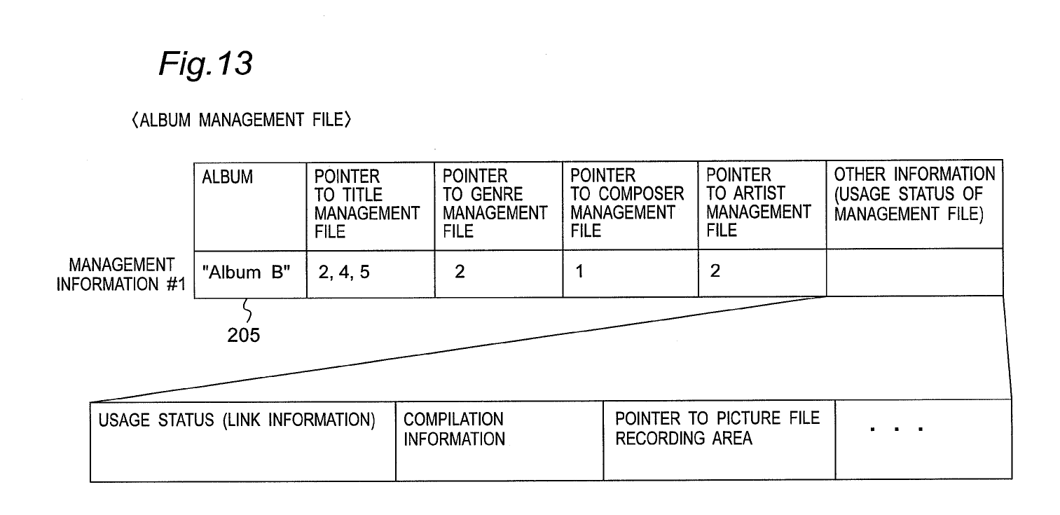

In each attribute management file, information to be recorded as other information is not limited to information indicating the usage status of an entry and link information on the entry. In addition to them, as shown in FIG. 13, flag information indicating whether an album is a compilation album, information indicating a location at which image data (picture data) for the album is recorded, and the like, may be recorded.

The size of management information in each attribute management file is not limited to 512 bytes and may be a variable length. Although the description is made that the configuration of each attribute management file itself has a variable length, it may be a fixed length. Although the attribute management files are configured as different files, it may be configured that information in the attribute management files is consolidated in one or several files.

### 1.2.6 Sort Information Management File

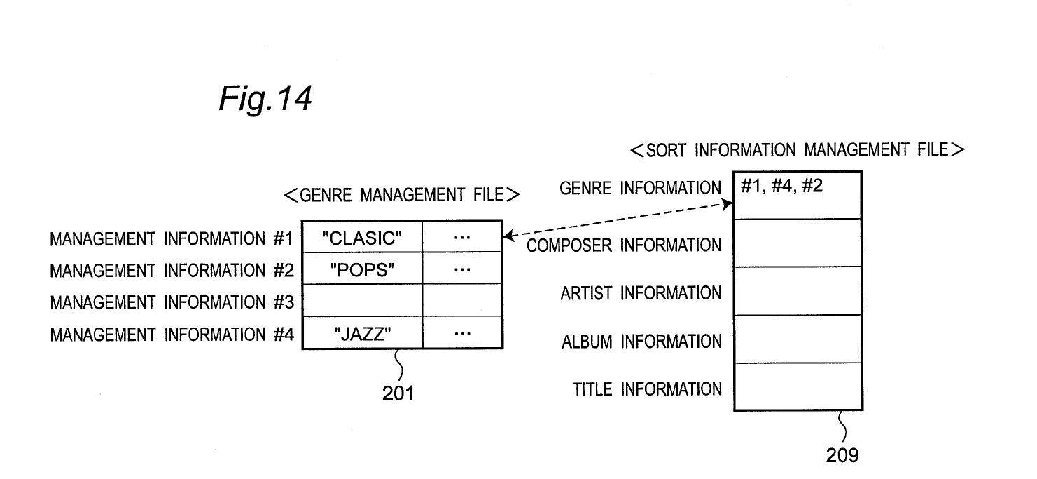

The sort information management file 209 that manages a sort status of management information (entry) in each attribute management file is described below with reference to FIG. 14.

FIG. 14 is a diagram showing exemplary configurations of the genre management file 201 and the sort information management file 209 for the genre management file 201.

The sort information management file 209 stores information indicating the order of management information having been subjected to sorting, for the case in which management information in the genre management file 201, the composer management file 211, the artist management file 203, the album management file 205, and the title management file 207 are sorted by text information managed by the respective attribute management files, i.e., by genre, composer, artist, album, and title, under a predetermined condition (procedure). Thus, the sort information management file 209 has areas for storing order of respective pieces of information sorted by each of genre, composer, artist, album, and title.

In an area of the sort information management file 209 which stores sort information for the genre, sort order of pieces of management information in the genre management file 201 for the case in which management information is sorted by a predetermined condition is recorded, using index number of management information in the genre management file 201.

For example, the case is considered, in which management information #1, management information #2, and management information #4 are used in the genre management file 201 and “CLASSIC”, “POPS”, and “JAZZ” are recorded as their respective genre names (text information). When the management information in the genre management file 201 is sorted alphabetically by genre name (text information), the order is the management information #1, the management information #4, and the management information #2. Hence, in the area of the sort information management file 209 where sort information on the genre is to be recorded, index numbers are recorded in the manner such as #1, #4, and #2. In this way, a status of management information in each attribute management file which is sorted by a predetermined condition is managed with index numbers, in the sort information management file 209. Thus, there is no need to actually sort management information in each attribute management file, making it possible to easily manage the order of management information having been subjected to sorting.

It becomes possible for a playback device to easily display a list in which genres are sorted in a predetermined order, by referring to the sort information management file 209. For composer, artist, album, and title, similarly, sort order information obtained after sorting management information in each attribute management file by a predetermined condition is managed in the sort information management file 209 using index numbers. As in the case described above, when each attribute management file is variable in length according to the number of pieces of management information to be recorded, an area of the sort information management file 209 that manages sort information on each piece of management information also becomes variable in length.

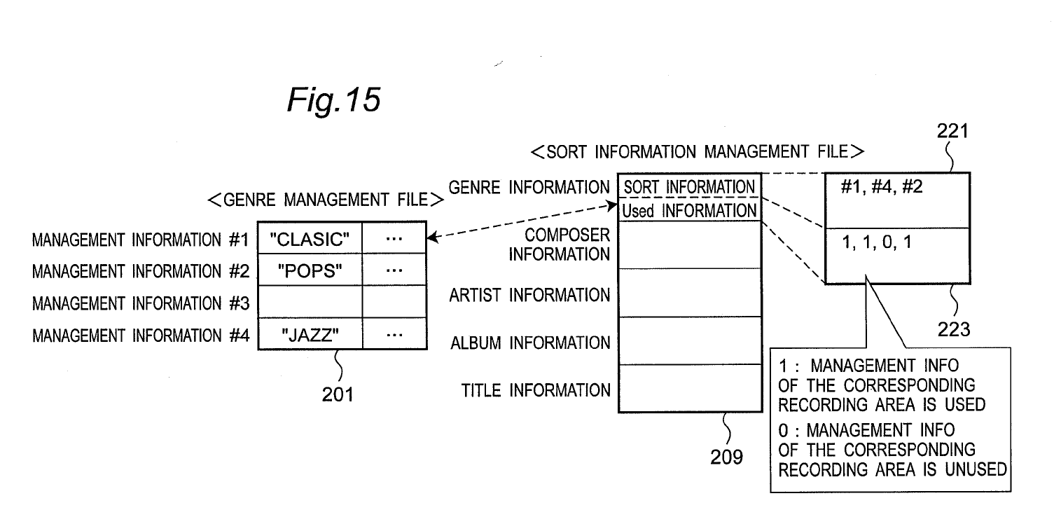

As shown in FIG. 15, the sort information management file 209 may store Used information 223 which is flag information indicating usage status of the respective management information entries in each attribute management file, in addition to index information 221 obtained after sorting. In the example of FIG. 15, in the genre management file 201, management information #1, management information #2, management information #3, and management information #4 are respectively “used”, “used”, “unused”, and “used”. Thus, the flag information “1”, “1”, “0”, and “1” is recorded as Used information 223 on genre information.

Although the above shows the configuration in which the sort information management file 209 is variable in length, the sort information management file 209 may be a fixed-length file. Although the example is shown in which the status of pieces of management information in the respective management information files which are sorted by a predetermined condition are collectively managed in one file, a file that manages sort information may be provided for each attribute management file. Namely, as long as a sorting status of management information in each attribute management file which is sorted by a predetermined condition can be managed, any configuration can be employed.

### 2. Recording Device

The configuration and operation of a recording device for the above-described semiconductor recording medium 100 will be described.

### 2.1 Configuration

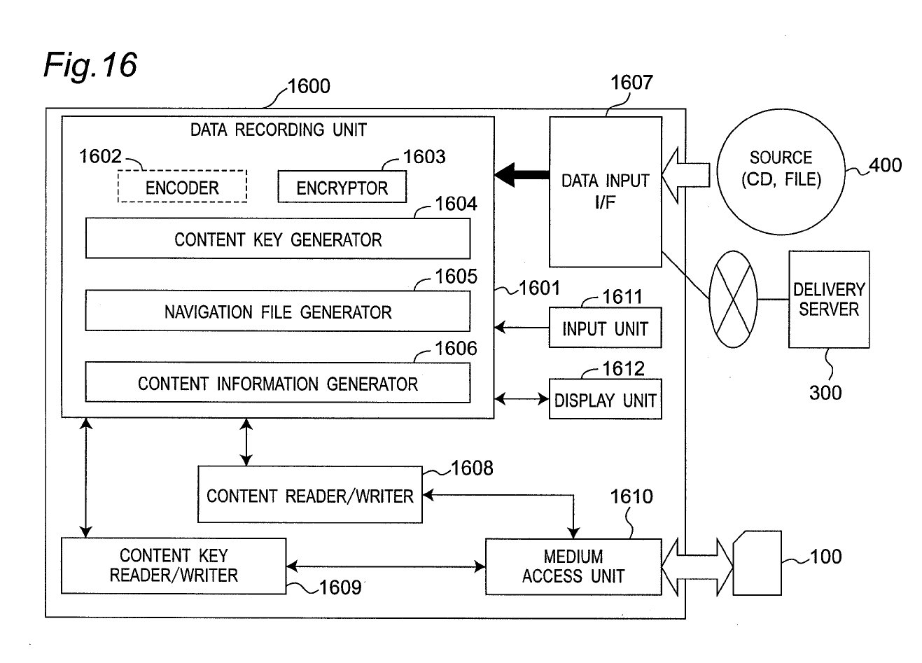

The configuration of a recording device is shown in FIG. 16. A recording device 1600 obtains content from a CD, a DVD, a file, or the like, or via various networks such as the Internet and a mobile phone network, and records the content in a semiconductor recording medium 100. The recording device 1600 is, for example, a PC (personal computer), a mobile (cellular) phone, a PDA (Personal Digital Assistant), a portable apparatus, a television, or the like.

The recording device 1600 includes a data input I/F unit 1607, a data recording unit 1601, a content reader/writer 1608, a content key reader/writer 1609, a medium access unit 1610, an input unit 1611, and a display unit 1612.

The data input I/F unit 1607 has a function of reading out a content file such as a CD, a DVD, or a file, and a network I/F function. The data input I/F unit 1607 has a function of receiving content and various information accompanying the content, such as genre, artist name, album name, composer's name, and song title, from a dedicated delivery server connected to the same network.

The data recording unit 1601 has a function of generating a content key, content information, and navigation information for the inputted content. The data recording unit 1601 includes an encoder 1602, an encryptor 1603, a content key generator 1604, a navigation file generator 1605, and a content information generator 1606.

The encoder 1602 has a function of encoding and compressing the content inputted through the data input I/F unit 1607, as required. Although the encoder 1602 is not necessarily required, in the present embodiment the inputted content is compressed by the encoder 1602 and then the compressed content is encrypted by the encryptor 1603.

The encryptor 1603 has a function of encrypting content with a content key generated by the content key generator 1604 to generate the encrypted content.

The content key generator 1604 has a function of generating a content key to be used for encrypting local content inputted from the data input I/F unit 1607. In the present embodiment, the content key generator 1604 has a random number generator and generates a content key using random numbers.

The content information generator 1606 has a function of processing attribute information on content, such as genre, artist, composer, album, and title, received from a delivery server 300 through the data input I/F unit 1607 to generate content information. The content information generator 1606 can also receive attribute information on content which is inputted by a user, through the input unit 1611 such as an input apparatus such as a keyboard or buttons.

The navigation file generator 1605 has a function of analyzing navigation files recorded in the semiconductor recording medium 100 and generating new navigation files based on the content information generated by the content information generator 1606.

The content reader/writer 1608 has a function of writing encrypted content together with navigation files to the semiconductor recording medium 100 through the medium access unit 1610 or reading navigation files and/or encrypted content recorded in the semiconductor recording medium 100.

The content key reader/writer 1609 has a function of writing or reading an encrypted content key generated by the data recording unit 1601, in the semiconductor recording medium 100 through the medium access unit 1610.

The medium access unit 1610 is loaded with the semiconductor recording medium 100 and has a function of accessing the loaded semiconductor recording medium 100. The medium access unit 1610 further has a function of reading out a medium unique key recorded in a special area 131 of the semiconductor recording medium 100 or performing authorization required for reading and writing of arbitrary digital data recorded in a protected area 132.

The input unit 1611 has a keyboard, various buttons, or the like through which a user can perform input of text information, and so on.

The display unit 1612 has a function of providing a screen or the like, capable of displaying various text information accompanying the content, and the like, such as genre, artist, composer, album, and title.

### 2.2 Recording Operation

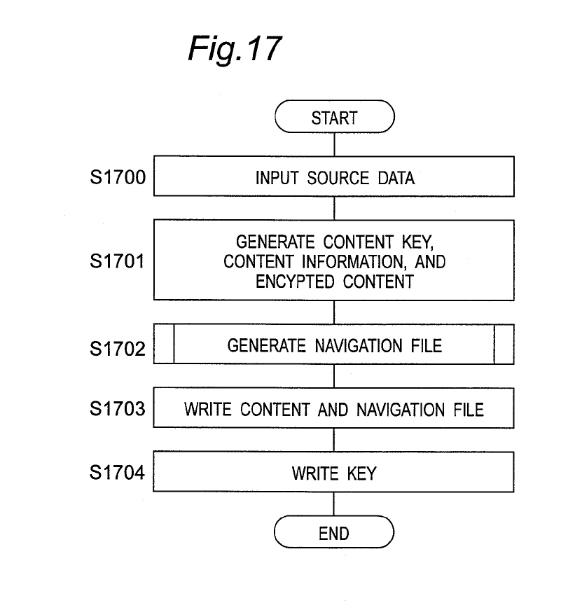

FIG. 17 is a flowchart showing an example of an operation sequence for the recording device 1600 which records content obtained through the data input I/F unit 1607 in the semiconductor recording medium 100.

First, the data input I/F unit 1607 of the recording device 1600 obtains content from a recording medium having source data recorded therein, such as a CD or DVD, or from an input apparatus such as a camera and a microphone, or via the Internet or a mobile phone network (S1700). The obtained content is sent to the data recording unit 1601.

The data recording unit 1601 generates a content key, content information, and encrypted content (S1701). Specifically, the data recording unit 1601 performs compression by encoding of local content with the encoder 1602. Furthermore, the content key generator 1604 generates a content key. The encryptor 1603 encrypts the encoded local content with the aforementioned content key to generate encrypted content. Furthermore, attribute information on the content, such as genre, composer, artist, album, and title, is obtained from the delivery server through the data input I/F unit 1607. Alternatively the attribute information on the content is generated by displaying data on the display unit 1612 of the recording device and receiving an input from the user through the input unit 1611 such as a keyboard or buttons, in response to a data change request or the like from a user.

Then, navigation files are generated (S1702). Navigation files (attribute management files such as a genre management file, an artist management file, a composer management file, an album management file, and a title management file, and a sort information management file) are read out from the semiconductor recording medium 100. Then the read navigation files are added with information based on the content information generated in step S1701 and stored in the data recording unit 1601. A specific operation of this will be described later.

The content reader/writer 1608 records the content encrypted by the encryptor 1603 in the data recording unit 1601 and the navigation files held inside in a normal area 133 of the semiconductor recording medium 100 through the medium access unit 1610 (S1703).

The content key reader/writer 1609 records the content key generated by the data recording unit 1601 in a protected area 132 of the semiconductor recording medium 100 through the medium access unit 1610 with the content key being encrypted with a medium unique key specific to the semiconductor recording medium 100 (S1704). Note that the write to the protected area 132 of the semiconductor recording medium 100 is enabled by mutual authorization of the medium access unit 1610 and the semiconductor recording medium 100.

### 2.2.1 Generation of Navigation Files

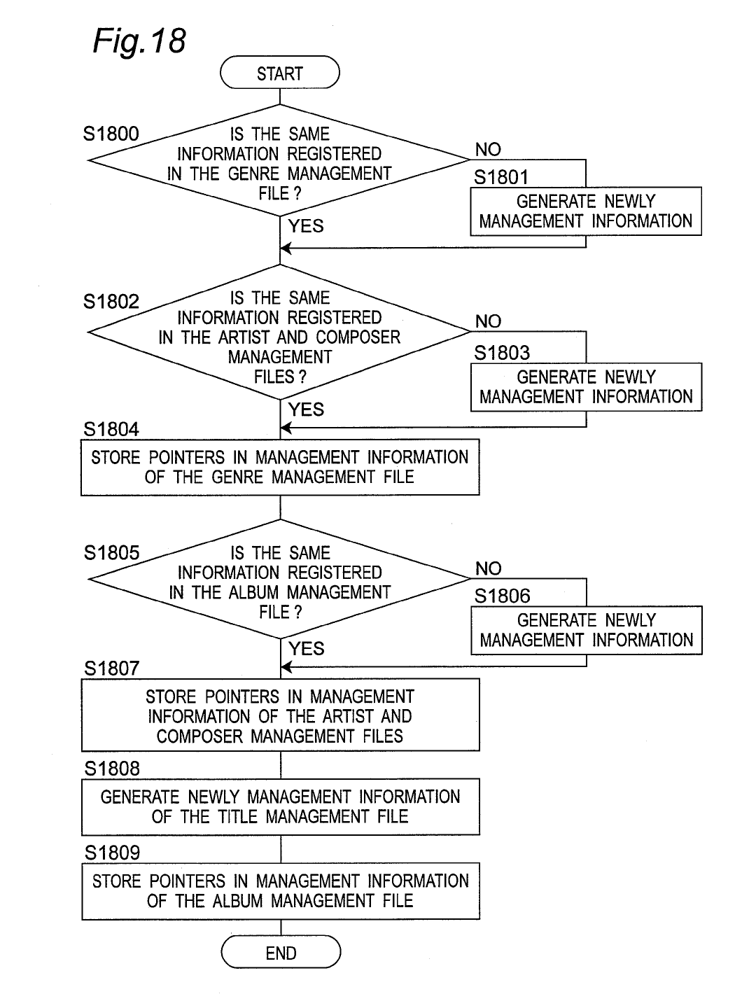

A detailed process of the aforementioned navigation files generation step (S1702) will be described with reference to a flowchart in FIG. 18.

First, by referring to a genre management file 201 recorded in the semiconductor recording medium 100, it is checked whether the same genre information as that on the content to be recorded now is contained in the genre management file 201 (S1800).

If the genre information on the content to be recorded is not contained in the genre management file 201, then management information is newly generated for the genre information (S1801).

Subsequently, management information in an artist management file 203 and a composer management file 211 is read out from the semiconductor recording medium 100. By referring to the read management information, it is checked whether the same artist information and composer information as those on the content to be recorded are already contained in the files (S1802).

If the artist information and composer information on the content to be recorded are not contained in the artist management file 203 and the composer management file 211, respectively, then management information is newly generated (S1803).

In the above-described step, in the artist management file 203 and the composer management file 211, management information (i.e., pointers) related to the content to be recorded is determined. A pointer to the artist management file 203 and a pointer to the composer management file 211 are recorded in management information in the genre management file 201, which is related to the content to be recorded (S1804).

Thereafter, management information in an album management file 205 is read out from the semiconductor recording medium 100. By referring to the read management information, it is checked whether the same album information as that on the content to be recorded is contained in the album management file 205 (S1805).

If the album information on the content to be recorded is not contained in the management information in the album management file 205, then management information is newly generated (S1806).

In the above-described step, in the album management file 205, management information including information related to the content to be recorded is determined. Subsequently, a pointer to the album management file is recorded in management information in the artist management file 203 and the composer management file 211 (S1807).

Then, based on title management information on the content to be recorded, management information in a title management file 207 is newly generated (S1808).

In the above-described step, in the title management file 207, management information including information related to the content to be recorded is determined. A pointer to the title management file 207 is recorded in management information in the album management file 205 (S1809).

Note that after completion of the steps (S1801, S1803, S1806, and S1808) of newly generating management information, sort information indicating a sort order for the case in which management information in each attribute management file is sorted by a predetermined condition is generated. Then the sort information management file 209 is updated based on the sort information. For example, when the management information in the genre management file 201 is sorted for the “genre” fields by a predetermined condition (e.g., alphabetical order) after adding management information to the genre management file 201 in step S1801, the order of sorted management information is recorded in the sort information management file 209.

As described above, the recording device 1600 can update and record navigation files and content in the semiconductor recording medium 100, according to the recording method shown in FIG. 3 and the directory configuration shown in FIG. 4.

### 3. Playback Device

The configuration and operation of a playback device for the above-described semiconductor recording medium 100 will be described.

### 3.1 Configuration

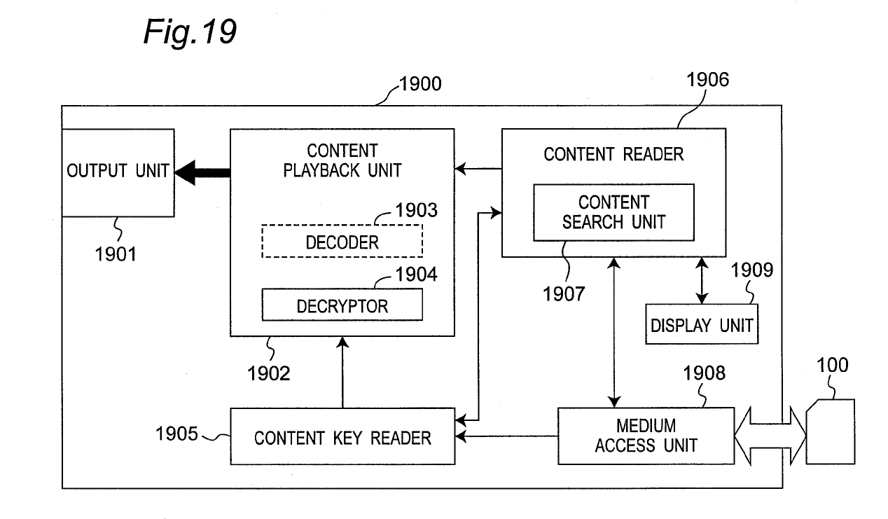

An example of the configuration of a playback device of the present embodiment is shown in FIG. 19. A playback device 1900 includes an output unit 1901, a content playback unit 1902, a content key reader 1905, a content reader 1906, a medium access unit 1908, and a display unit 1909.

The content reader 1906 has a function of reading out content, navigation files, or a playlist file from a semiconductor recording medium 100. The content reader 1906 includes a content search unit 1907 and the content search unit 1907 has a function of reading out navigation files or a playlist file which are recorded in the semiconductor recording medium 100 and displaying information thereof on the display unit 1909 mounted on the playback device 1900. The content reader 1906 also searches for hierarchical navigation files or a playlist file and performs a narrowing-down selection of content, according to information selected by a user, and eventually searches the semiconductor recording medium 100 for content that the user desires. The searched content is encrypted and is sent to the content playback unit 1902. In addition, the content reader 1906 holds information indicating recording locations of content keys in the semiconductor recording medium 100 and has a function of outputting the information.

The content key reader 1905 has a function of reading out an encrypted content key recorded in the semiconductor recording medium 100 through the medium access unit 1908 based on the information indicating the recording locations of the content keys which is received from the content reader 1906, decrypting the read encrypted content key to generate a plaintext content key, and outputting the plaintext content key to the content playback unit 1902.

The content playback unit 1902 has a function of decrypting the content (encrypted content) received from the content reader 1906 with the content key received from the content key reader 1905, performing a decompression process, and reproducing the content. A decryptor 1904 performs a process of decrypting the encrypted content with a content key. The content playback unit 1902 includes the decryptor 1904 and a decoder 1903. When the content decrypted by the decryptor 1904 is compressed, the decoder 1903 performs a process of decompressing the content to restore the content to a state before compression. Note that the decoder 1903 may not need to be provided when the content is not compressed.

The output unit 1901 has a function of outputting content data decrypted by the content playback unit 1902. For example, the output unit 1901 corresponds to a speaker when the content data is audio data, and corresponds to a display when the content data is video data or character data. When a display or speaker provided external to the playback device 1900 is used, the output unit 1901 corresponds to an output terminal such as AV-OUT.

The medium access unit 1908 is loaded with the semiconductor recording medium 100 and has a function of accessing the loaded semiconductor recording medium 100. The medium access unit 1908 has a function of reading out a medium unique key recorded in a special area 131 of the semiconductor recording medium 100 or performing authorization process required for reading and writing arbitrary digital data for a protected area 132.

The display unit 1909 includes a liquid crystal display device (LCD), for example, and has a function of displaying information on content, navigation files, or a playlist file, which are read by the content reader 1906.

### 3.2 Playback Operation

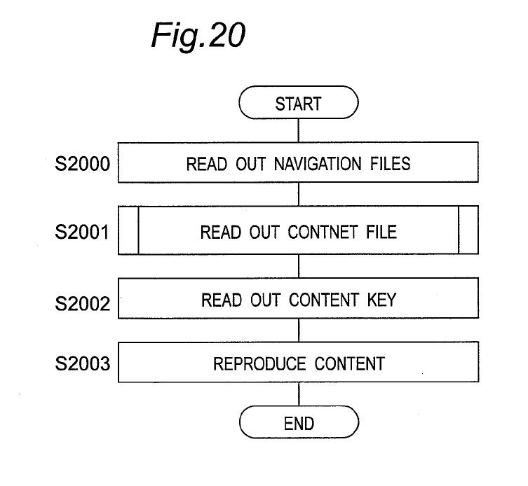

FIG. 20 is a flowchart showing an exemplary operation sequence for the playback device 1900 which reproduces content recorded in the semiconductor recording medium 100.

First, the content reader 1906 of the playback device 1900 reads out navigation files or a playlist file recorded in the semiconductor recording medium 100, through the medium access unit 1908 (S2000).

Then, a content file is read out according to an instruction from a user (S2001). Specifically, based on information in the read navigation files or playlist file, a selection menu is displayed on the display unit 1909 of the playback device 1900 and the user is allowed to select desired content through the selection menu. According to the selection by the user, the content search unit 1907 searches for the navigation files, the playlist file, and the content file. Thus obtained content data and attribute information on content are sent to the content playback unit 1902 and the content key reader 1905. A detail of this process and exemplary displays on the display unit 1909 will be described later.

Subsequently, a content key (encrypted content key) for decrypting the encrypted content is read out (S2002). The content key reader 1905 identifies a recording location of the encrypted content key based on information received from the content reader 1905 and reads out the encrypted content key from the semiconductor recording medium 100 through the medium access unit 1908. The content key read out from the semiconductor recording medium 100 is being encrypted with a medium unique key which is specific to the semiconductor recording medium 100. Thus, first, it needs to read out the medium unique key from the semiconductor recording medium 100 and calculate a plaintext content key from the read content key using the medium unique key.

The thus obtained content key is sent to the content playback unit 1902. Note that the reading of the content key is enabled by mutual authorization between the medium access unit 1909 and the semiconductor recording medium 100.

Finally, by using the content and content key read out from the semiconductor recording medium 100, the content is decrypted and reproduced (S2003). The decryptor 1904 in the content playback unit 1902 decrypts the content received from the content reader 1905 using the content key received from the content key reader 1905. The decoder 1903 performs a decompression process on the decrypted content and transmits the decompressed content to the output unit 1901. This implements the playback of the content.

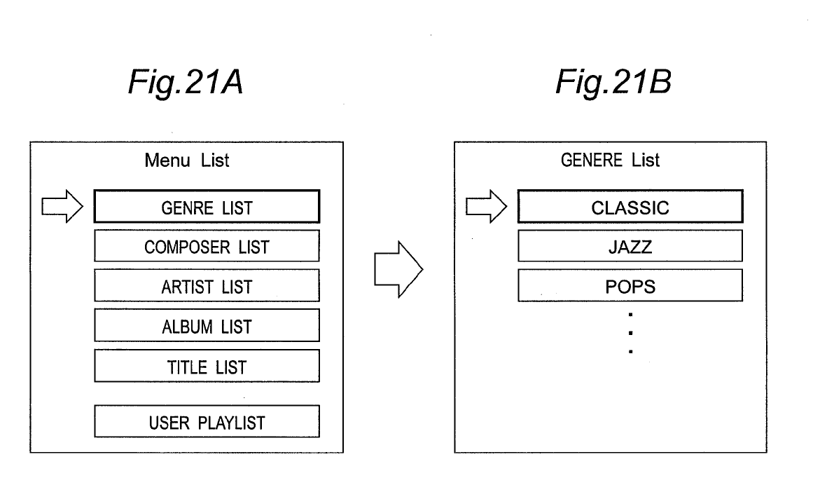

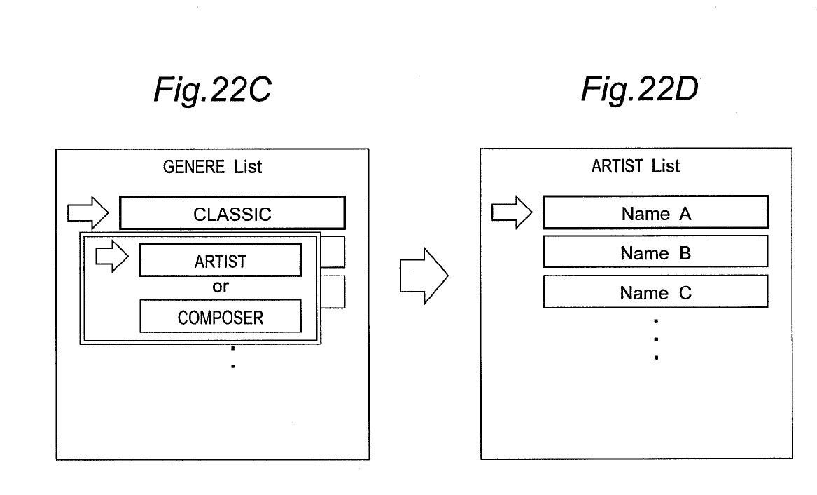

FIGS. 21A, 21B, 22C, and 22D show exemplary displays of selection menus on the display unit 1909 of the playback device 1900, based on navigation information read out from the semiconductor recording medium 100 at the aforementioned step S2001. The displays transition as follows: FIG. 21A→FIG. 21B→FIG. 22A→FIG. 22B.

FIG. 21A is a diagram showing an example of an initial menu to be displayed first on the display unit 1909 of the playback device 1900. The user can select one item from selection items including “genre list”, “composer list”, “artist list”, “album list”, “title list”, and “user playlist”. FIG. 21B shows an exemplary display when the “genre list” is selected in the selection menu shown in FIG. 21A. In the selection menu at this time, genres managed by the genre management file 201 are displayed according to a sort order managed by the sort information management file 209.

FIG. 22C shows an exemplary display when “CLASSIC” is selected in the selection menu shown in FIG. 21B. At this time, a screen for confirming whether the selection is made from “artist” or “composer” is further displayed. That is, management information in the genre management file 201 recorded in the semiconductor recording medium 100 has a pointer to the artist management file 203 and a pointer to the composer management file 211, and thus the user can select one of the management files of which information is to be displayed.

FIG. 22D shows an exemplary display for the case in which “artist” is selected in the selection menu in FIG. 22C. Based on the pointer to the artist management file which is recorded in the genre management file 201, artist information is displayed. At that time, the display order follows a sort order managed by the sort information management file 209. After this, a user's selection hierarchically proceeds from album to title. Selection items are displayed based on pointer information in each attribute management file recorded in the recording medium 100 and sort information managed by the sort information management file 209.

Note that the display of screens is not limited to the aforementioned examples and an arbitrary display format is possible. For example, in an initial selection menu, only a list of a user playlist may be displayed, and when a specific action (e.g., pressing a button) is taken, the operation may shift to a narrowing-down operation of content.

As described above, by effectively using navigation files in the playback device 1900, content that the user desires can be effectively narrowed down from numbers of pieces of content and reproduced.

### 3.2.1 Detail of Content Playback Process

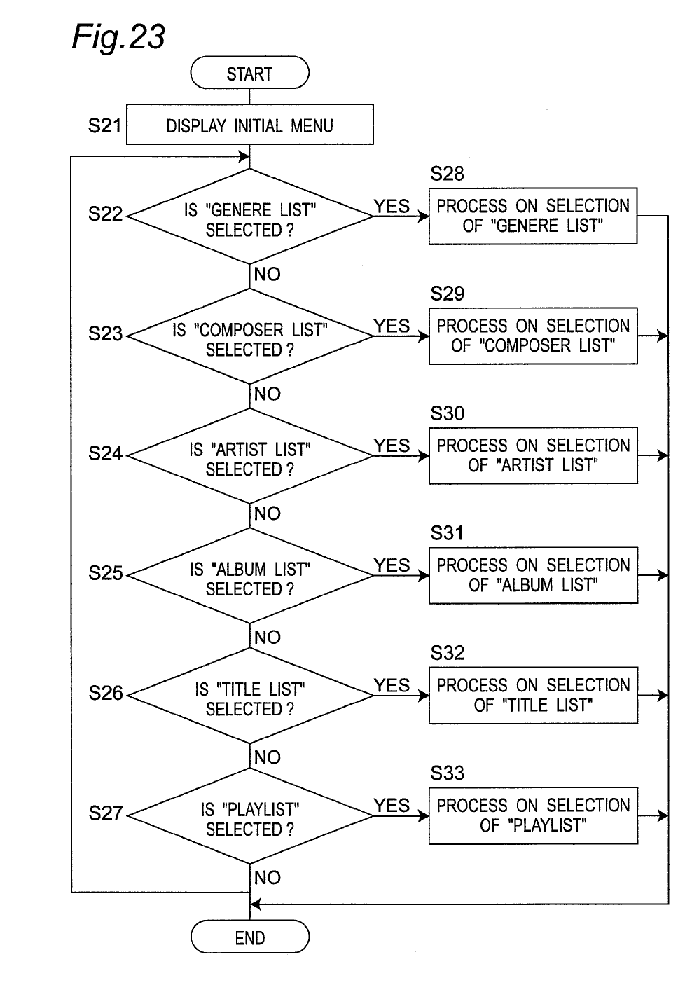

A detail of the content file read-out process in step S2001 will be described using FIGS. 23 to 27.

### (a) Initial Menu Process

FIG. 23 shows the flow of a display of an initial menu (initial selection screen) in FIG. 21A and a process for the selection made by the user in the initial menu. First, an initial menu (“Menu List”) shown in FIG. 21A is displayed on the display unit 1909 (S21). If the item “genre list” is selected by the user in the initial menu (YES at S22), then a process on selection of “genre list” is performed (S28). If the item “composer list” is selected (YES at S23), then a process on selection of the “composer list” is performed (S29). If the item “artist list” is selected (YES at S24), then a process on selection of the “artist list” is performed (S30). If the item “album list” is selected (YES at S25), then a process on selection of the “album list” is performed (S31). If the item “title list” is selected (YES at S26), then a process on selection of the “title list” is performed (S32). If the item “playlist display” is selected (YES at S27), then a process on selection of the “playlist display” is performed (S33).

### (b) Process on Selection of Genre List

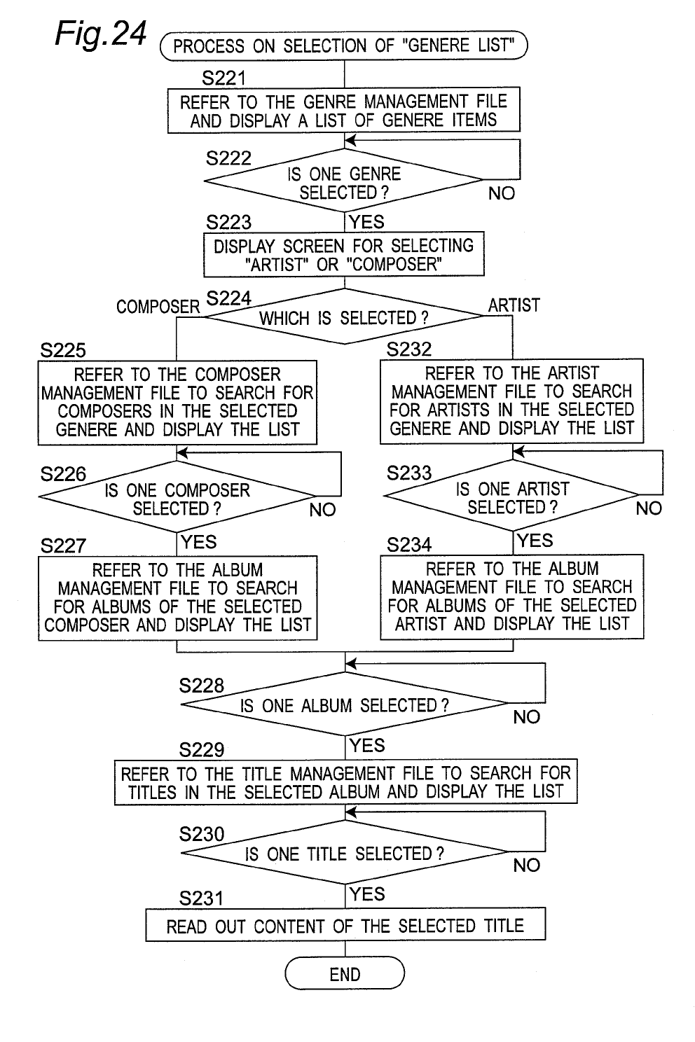

The process on Selection of genre list will be described with reference to a flowchart in FIG. 24. If the “genre list” is selected in the initial menu shown in FIG. 21A, then the genre management file 201 is referred to and a list of genre items (text information on management information) such as that shown in FIG. 21B is displayed (S221). Specifically, information (genre names) described in the “genre” fields of respective pieces of management information in the genre management file 201 is obtained and the genre names are sorted according to a sort order recorded in the sort information management file 209 and then displayed.

The user can select a desired genre from a list of genre items as shown in FIG. 21B. If a selection of one genre is made by the user (YES at S222), then a screen for selecting either “artist” or “composer” as shown in FIG. 22A is displayed (S223).

If the “artist” is selected by the user (S224), then the artist management file 203 is referred to, artists (artist names), such as those in FIG. 22B belonging to the selected genre are searched for, and a list thereof is displayed (S232). At this time, the artists (artist names) are displayed in a predetermined sort order. For example, the artists are sorted according to a sort order recorded in the sort information management file 209 and then displayed. When pointers registered in the “pointer to the artist” in the genre management file 201 are already sorted, the sort information management file 209 does not need to be referred to for sorting and the artists may be displayed in the order shown by the registered pointers (which also applies to the case in which information in other attribute management files is displayed in a list).

Information (artist names) on the artists belonging to the selected genre can be obtained as follows. In the genre management file 201, management information relating to the selected genre is identified. By referring to the “pointer to the artist management file” in the identified management information, management information on the artists related to the selected genre in the artist management file 203 is identified. Then, from the identified management information in the artist management file 203, artist names belonging to the selected genre are obtained.

After displaying the artist list, if a selection of one artist is made by the user (YES at S233), then the album management file 205 is referred to, albums of the selected artist are searched for, and a list thereof is displayed (S234). At this time, information on the searched albums is sorted according to a sort order recorded in the sort information management file 209, for example, and then displayed.

Information (album names) on the albums of the selected artist can be obtained as follows. In the artist management file 203, management information relating to the selected artist is identified. By referring to the “pointer to the album management file” in the identified management information, management information on the albums related to the selected artist in the album management file 205 is identified. Then, from the identified management information in the album management file 205, information on the albums related to the selected artist is obtained.

On the other hand, if in step S224 the “composer” is selected by the user, then the composer management file 211 is referred to, composers belonging to that genre are searched for, and a list thereof is displayed (S225). At this time, information on the searched composers is sorted according to a sort order recorded in the sort information management file 209, for example, and then displayed.

After displaying the composer list, if a selection of one composer is made by the user (YES at S226), then the album management file 205 is referred to, albums of the selected composer are searched for, and a list thereof is displayed (S227). As with step S234, by referring to the “pointer to the album management file” in the composer management file 211, information on albums related to the selected composer can be obtained.

After displaying the album list, if one album is selected by the user (YES at S228), then the title management file 207 is referred to, titles included in the selected album are searched for, and a list thereof is displayed (S229). At this time, information on the searched titles is sorted according to a sort order recorded in the sort information management file 209, for example, and then displayed.

Specifically, in the album management file 205, management information relating to the selected album is identified. By referring to the “pointer to the title management file” in the identified management information, management information on titles related to the selected album in the title management file 207 is identified. Then, from the identified management information in the title management file 207, information on the titles related to the selected album is obtained.

After displaying the title list, if one title is selected by the user (YES at S230), then content of the selected title is read out from the semiconductor recording medium 100 (S231). A recording location of the content can be recognized by referring to the “pointer to the content recording location” in the title management file 207.

### (c) Process on Selection of Composer (Artist) List

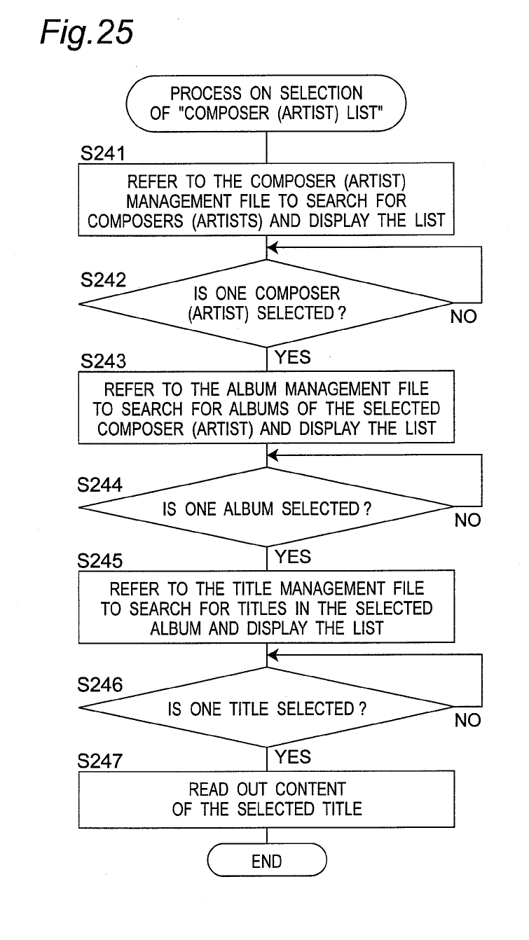

The process on selection of composer list (or the process on selection of artist list) will be described with reference to a flowchart in FIG. 25.

If the “composer list” (or the “artist list”) is selected by the user in the initial menu, then the composer management file 211 (or the artist management file 203) is referred to, composers (or artists) are searched for, and a list thereof is displayed (S241). At this time, the searched composers (or artists) are sorted according to a sort order recorded in the sort information management file 209 and then displayed.

After displaying the composer (or artist) list, if a selection of one composer (or one artist) is made by the user (YES at S242), then the album management file 205 is referred to, albums of the selected composer (or artist) are searched for, and a list thereof is displayed (S243).

After displaying the album list, if one album is selected by the user (YES at S244), then the title management file 207 is referred to, titles included in the selected album are searched for, and a list thereof is displayed (S245).

After displaying the title list, if one title is selected by the user (YES at S246), then content of the selected title is read out from the semiconductor recording medium 100 (S247).

### (d) Process on Selection of Album List

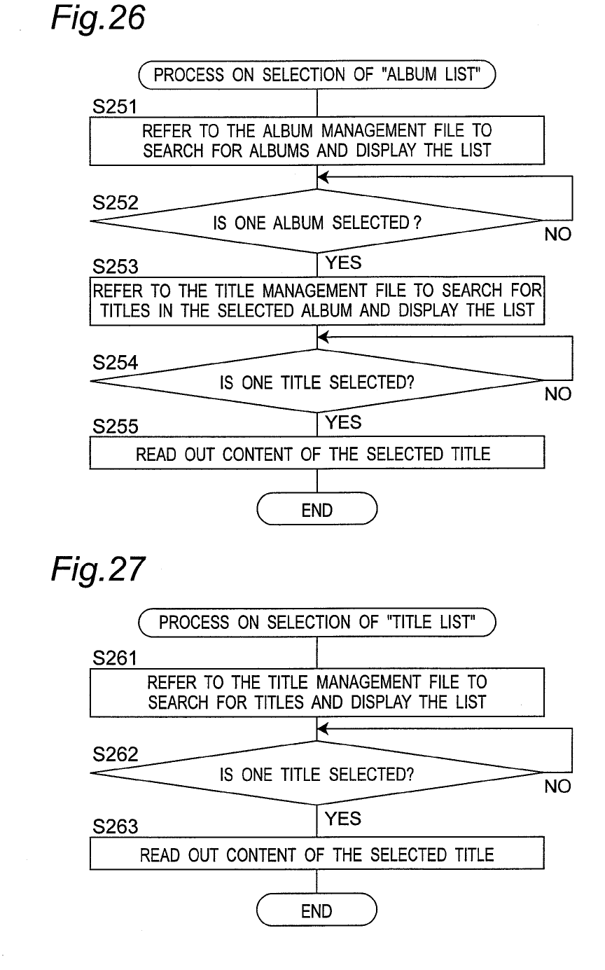

The process on selection of album list will be described with reference to a flowchart in FIG. 26.

If the “album list” is selected by the user in the initial menu, then the album management file 205 is referred to and a list thereof is sorted and then displayed (S251). At this time, information on the albums is sorted according to a sort order recorded in the sort information management file 209, for example, and then displayed.

After displaying the album list, if one album is selected by the user (YES at S252), then the title management file 207 is referred to, titles included in the selected album are searched for, for example, and a list thereof is sorted and then displayed (S253).

After displaying the title list, if one title is selected by the user (YES at S254), then content of the selected title is read out from the semiconductor recording medium 100 (S255).

### (e) Process on Selection of Title List

The process on selection of title list will be described with reference to a flowchart in FIG. 27.

If the “title list” is selected by the user in the initial menu, then the title management file 207 is referred to, titles are searched for, and a list thereof is sorted, for example, and then displayed (S261).

After displaying the title list, if one title is selected by the user (YES at S262), then content of the selected title is read out from the semiconductor recording medium 100 (S263) Note that, although here a detailed description is omitted, when the “playlist” is selected by the user in the initial menu and the user selects the content, the selected content which is registered in the playlist is read out from the semiconductor recording medium 100.

In the above-described manner, in the present embodiment, management files (attribute management files) 201, 203 . . . , are provided for respective attributes (genre, artist, composer, album, title, etc.) relating to the content. The attribute management files 201, 203 . . . , are hierarchically linked to one another. The link information (pointer) is managed by each attribute management file. Thus, a narrowing-down extraction of desired content is enabled with a simple configuration. In addition, information on a sort order to be obtained in the case where information managed by each attribute management file is sorted by a predetermined condition, is managed by a file (sort information management file 209) which is different from the attribute management files. By thus providing the sort information management file 209, there is no need to sort entries in the attribute management files upon addition or deletion of content and while suppressing an increase in the cumbersomeness of an update process for the attribute management files, facilitation of a search based on the attributes of content recorded in a semiconductor recording medium 100 is implemented.

### Second Embodiment

A second embodiment of the present invention will be described below. The present embodiment is different from the first embodiment in a method of storing information on a pointer to management information in each attribute management file in navigation files. Other configuration and operation are the same as basic points. The configurations of a recording device and a playback device of the present embodiment are the same as those in the first embodiment.

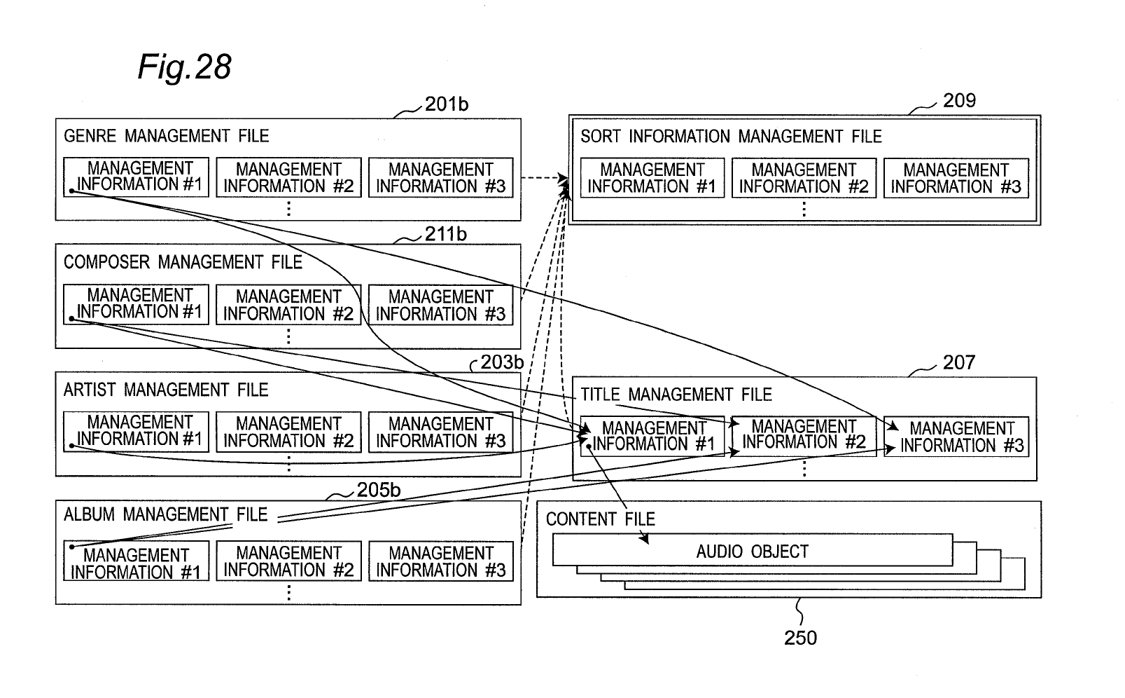

FIG. 28 is a diagram showing a relationship between navigation files and a content file containing audio objects in the present embodiment. The navigation files include a genre management file 201b, a composer management file 211b, an artist management file 203b, an album management file 205b, a title management file 207, and a sort information management file 209.

Each of the attribute management files, including the genre management file 201b, the composer management file 211b, the artist management file 203b, the album management file 205b, and the title management file 207, contains text information and information on a pointer to the title management file.

For example, in FIG. 28, pointers to management information #1 and management information #3 of the title management file 207 are recorded in management information #1 contained in the genre management file 201b. In the drawing, an arrow indicates a destination pointed by pointer information. Similarly, pointers to the title management file 207 are recorded in management information in the other attribute management files too. A pointer relating to a recording location of content is recorded in management information in the title management file 207. By referring to the pointer, a content file 250b can be identified.

As with the first embodiment, the sort information management file 209 manages a sort order for the case in which management information in each of the attribute management files, including the genre management file 201b, the composer management file 211b, the artist management file 203b, the album management file 205b, and the title management file 207, is sorted. In the drawing, dashed-line arrows indicate that sort information on each attribute management file is recorded in the sort information management file 209.

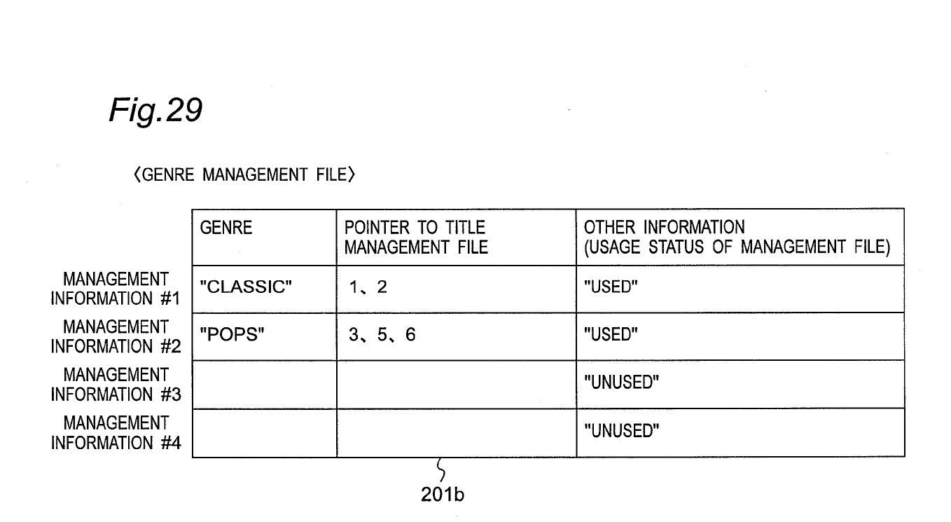

FIG. 29 is a diagram showing exemplary recording of information in the genre management file 201b. Each management information in the genre management file 201b includes “genre (text information)”, “pointer to the title management file”, and “other information”, having a total of 512 bytes length. In management information #1, “1” and “2” are recorded as pointers to the title management file 207. This indicates that titles belonging to the genre “CLASSIC” belong to management information #1 and management information #2 in the title management file 207.

Similarly, in management information #2 in the genre management file 201b, “3, 5, and 6” are recorded as pointers to the title management file 207. This indicates that titles belonging to the genre “POPS” belong to management information #3, management information #5, and management information #6 in the title management file 207. In management information #3 and management information #4, “unused” is recorded as other information. This indicates that although an area for recording information itself is reserved, it is not used as management information. Here, there are no particular limitations on what number of management information is used for genre information. Note that although in the aforementioned example a flag indicating a usage status is held in individual management information, as another example, a method may be employed in which in a starting portion of a management file is provided an area for performing overall management of the entire usage status in the file, or a method may be employed in which management is performed using another file.

The configuration of the composer management file 211b, the artist management file 203b, and the album management file 205b in the present embodiment is also the same as that of the genre management file 201b and thus a detailed description thereof is omitted. The configuration of the title management file 207 is the same as that in the first embodiment shown in FIG. 11.

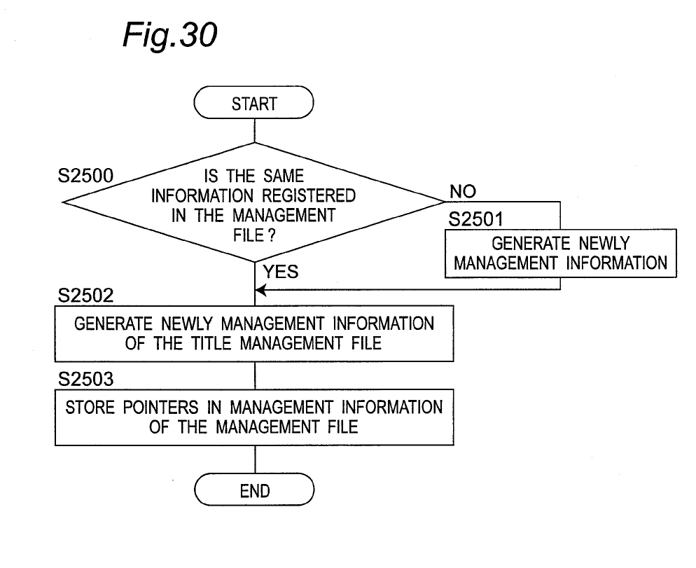

FIG. 30 is a flowchart showing navigation files generation process. The process is performed by a recording device 1600. The flowchart shows a generation process for attribute management files including a genre management file 201b, a composer management file 211b, an artist management file 203b, and an album management file 205b.

First, by referring to attribute management files (a genre management file 201b, a composer management file 211b, an artist management file 203b, and an album management file 205b) recorded in a semiconductor recording medium 100, it is checked whether the same genre information as that on content to be recorded now is included in management information in the respective attribute management files 201b, . . . (S2500).

If the information on the content to be recorded is not included in the management information in the respective attribute management files 201b, . . . , then management information on the genre information is newly generated (S2501).

Then, management information is newly generated in the title management file 207 (S2502).

By the aforementioned step, in the title management file 207, management information (i.e., pointers) related to the content to be recorded is determined. Then, pointers to the title management file 207 are recorded in management information in the respective attribute management files 201b, . . . (S2503).

Sort information indicating a sort order for the case in which management information in each attribute management file is sorted by a predetermined condition when management information is newly generated in each of the aforementioned steps, is generated and recorded in the sort information management file 209.

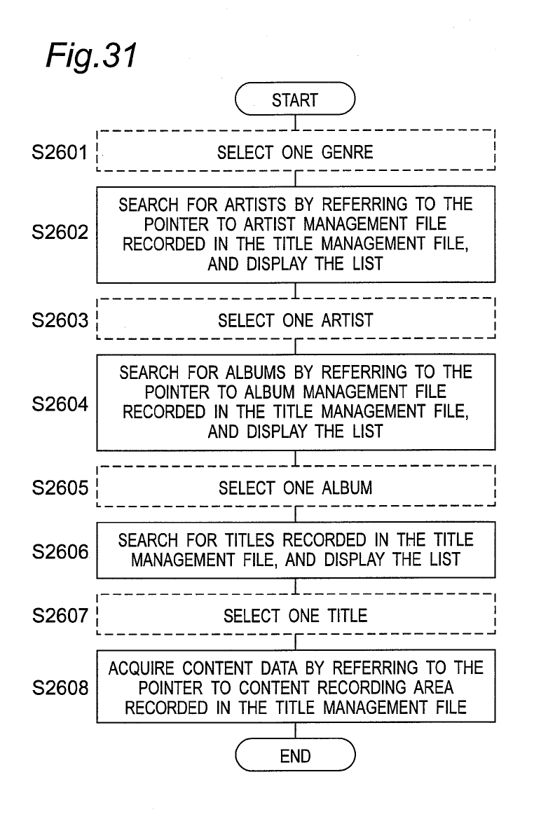

FIG. 31 is a flowchart showing an operation of a playback device 1900 on selection of playback content. The flowchart shows an operation of the playback device 1900 to be performed when a user selection is made in the manner shown in FIGS. 21A, 21B, 22C, and 22D. Note that a dashed line in FIG. 31 indicates an input to the playback device, i.e., an operation by a user.

If one genre is selected by the user from a genre list in the selection menu shown in FIG. 21B, then information on the selection is inputted to the playback device 1900 (S2601). Thereafter, a menu for selecting a “composer” or an “artist” as shown in FIG. 22C, is displayed. In the present example, it is assumed that the “artist” is selected by the user.

In the playback device 1900, based on the “pointer to the title management file” registered in management information in the genre management file 201b for the selected genre, management information in the title management file 207 is obtained. From the “pointer to the artist management file” included in the obtained management information, information on artists is searched for and search results are displayed as an artist list (S2602). Accordingly, the artist list as shown in FIG. 22D is displayed.

Then, if one artist is selected by the user from the artist list shown in FIG. 22D, then information on the selection is inputted to the playback device 1900 (S2603).

Based on the “pointer to the title management file” registered in management information in the artist management file 203b for the selected artist, management information in the title management file 207 is obtained. From the “pointer to the album management file” included in the obtained management information, album information is searched for and search results are displayed as an album list (S2604).

If one album is selected by the user from the album list, then information on the selection is inputted to the playback device 1900 (S2605).

Based on the “pointer to the title management file” registered in management information in the album management file 205b for the selected album, management information in the title management file 207 is obtained. Obtained results are displayed as a title list (S2606).

If one title is selected by the user from the title list, then information on the selection is inputted to the playback device 1900 (S2607).

Based on the “pointer to the content recording location” registered in management information in the title management file 207 for the selected title, content data is obtained (S2608). Thereafter, the obtained content data is subjected to decryption and decompression processes and then reproduced.

In this way, according to the present embodiment, all management files in the navigation files other than the title management file 207 store pointers to the title management file. With this configuration, addition or deletion of an attribute management file itself can be easily and flexibly handled.

### Third Embodiment

A third embodiment of the present invention will be described below. The present embodiment is different from the first and second embodiments in a method of storing management information in each attribute management file in navigation files. Other configuration and operation are the same as basic points. The configurations of a recording device and a playback device of the present embodiment are the same as those in the first embodiment.

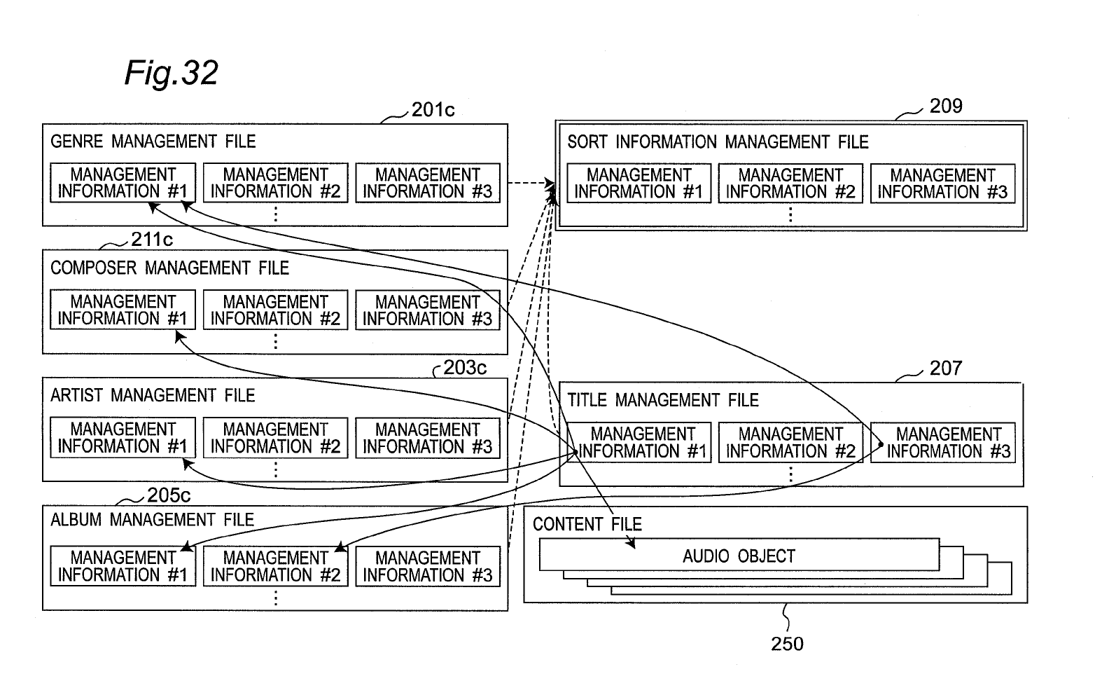

FIG. 32 is a diagram showing a relationship between navigation files and a content file containing audio objects in the present embodiment. The navigation files include a genre management file 201c, a composer management file 211c, an artist management file 203c, an album management file 205c, a title management file 207, and a sort information management file 209.

Each of attribute management files, including the genre management file 201c, the composer management file 211c, the artist management file 203c, the album management file 205c, and the title management file 207, contains text information indicating content of an attribute and reference count information indicating the number of pieces of management information related to the attribute which are registered in the other attribute management files. In the present embodiment, the attribute management files 201c, . . . , do not contain information on pointers to other management files.

In management information in the title management file 207, as with the first embodiment, a pointer relating to a recording location of content is recorded. By referring to the pointer, a content file 250 can be identified.

As with the first embodiment, the sort information management file 209 manages a sort order for the case in which management information in each of the attribute management files including the genre management file 201c, the composer management file 211c, the artist management file 203c, the album management file 205c, and the title management file 207, is sorted. In the drawing, dashed-line arrows indicate that sort information on each attribute management file is recorded in the sort information management file 209.

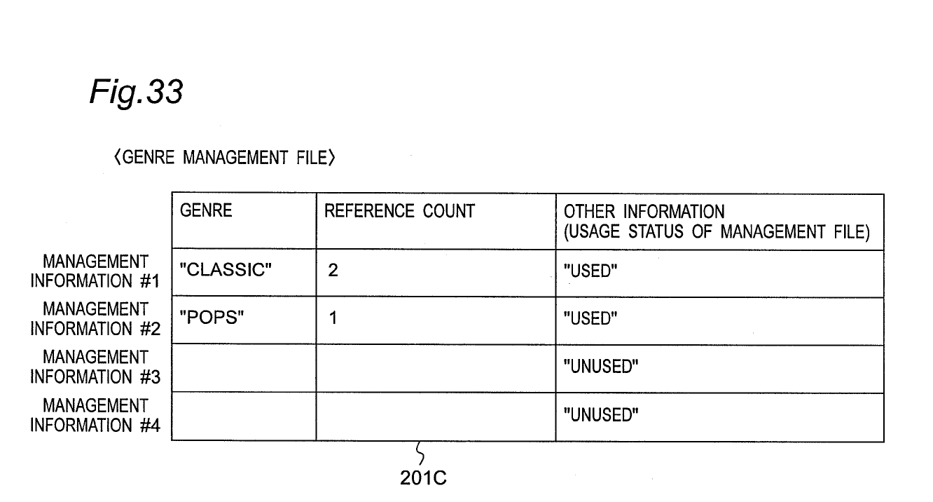

FIG. 33 is a diagram showing exemplary recording of information in the genre management file 201c. Each piece of management information in the genre management file 201c includes “genre (text information)”, “reference count”, and “other information”, having a total of 512 bytes length. In management information #1, “2” is recorded as a reference count. This indicates that titles belonging to the genre “CLASSIC” are used in two of all pieces of management information in the title management file 207.

Similarly, in management information #2 in the genre management file 201c, “1” is recorded as a reference count. This indicates that a title belonging to the genre “POPS” is used in one of all pieces of management information in the title management file 207. In management information #3 and management information #4, “unused” is recorded as other information. This indicates that although an area for recording information itself is reserved, it is not used as management information. Here, there are no particular limitations on what number of management information is used for genre information. The example is shown in which a flag indicating the usage status is held in individual management information. However, as another example, a method may be employed in which in a starting portion of a management file is provided an area for performing overall management of the entire usage status in the file, or a method may be employed in which management is performed using another file.

The configuration of the composer management file 211c, the artist management file 203c, and the album management file 205c in the present embodiment is also the same as that of the genre management file 201c and thus a detailed description thereof is omitted. The configuration of the title management file 207 is the same as that in the first embodiment shown in FIG. 11.

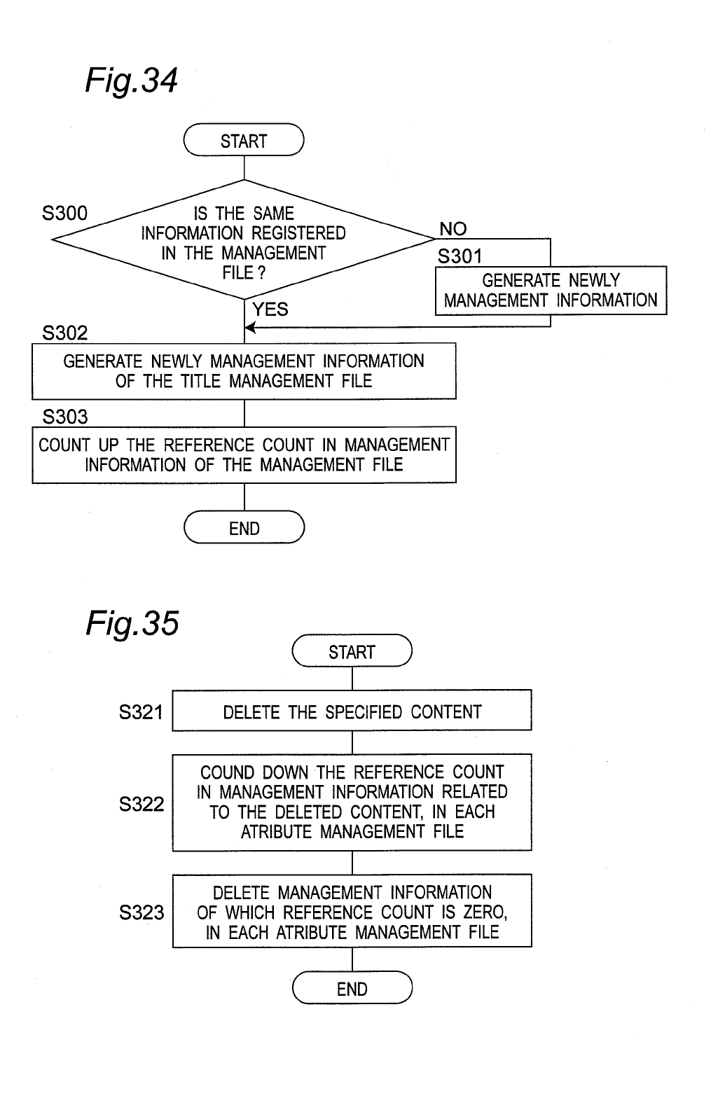

FIG. 34 is a flowchart showing navigation files generation process in the present embodiment. The process is performed by a recording device 1600. The flowchart shows a generation process for attribute management files including a genre management file 201c, a composer management file 211c, an artist management file 203c, and an album management file 205c.

First, by referring to attribute management files (a genre management file 201c, a composer management file 211c, an artist management file 203c, and an album management file 205c) recorded in a semiconductor recording medium 100, it is checked whether the same genre information as that on content to be recorded now is included in management information in the respective attribute management files 201c, . . . (S300).

If the information on the content to be recorded is not included in the management information in the respective attribute management files 201c, . . . , then management information on the genre information is newly generated (S301).

Then, management information is newly generated in the title management file 207 (S302).

By the aforementioned step, in the title management file 207, management information (i.e., pointers) related to the content to be recorded is determined. Then, a value (“1” for the case of new generation) obtained by counting up reference counts in management information in the respective attribute management files 201c, . . . , is recorded (S303).

Note that sort information indicating a sort order for the case in which management information in each attribute management file is sorted by a predetermined condition when management information is newly generated in each of the aforementioned steps, is generated and recorded in the sort information management file 209.

An operation of a playback device 1900 on selection of content to be reproduced of the present embodiment will be described with reference to FIG. 31. Here, an operation of the playback device 1900 to be performed when a user selection is made in the manner shown in FIGS. 21A, 21B, 22C, and 22D is shown. Note that, as described above, a dashed line in FIG. 31 indicates an input to the playback device, i.e., an operation by a user.

If one genre is selected by the user from a genre list in a selection menu shown in FIG. 21B with the genres sorted according to a sort order recorded in the sort information management file 209, then information on the selection is inputted to the playback device 1900 (S2601). Thereafter, a menu for selecting a “composer” or an “artist” as shown in FIG. 22C, is displayed. In the present example it is assumed that the “artist” is selected by the user.

In the playback device 1900, management information related to the selected genre is obtained from the title management file 207. Specifically, in the genre management file 201c, management information (entry number thereof) including the same genre information as that on the selected genre is identified. For example, in the example of FIG. 33, when the selected genre is “POPS”, management information #2 is identified (the entry number is “2”). Then, in the tile management file 207, management information whose value of the “pointer to the genre management file” matches the entry number of the identified management information is identified. By using the “pointer to the artist management file” included in the identified management information, information on artists is searched for through the artist management file 203c and the search results are displayed as a artist list (S2602). At this time, the information on artists is displayed according to a predetermined sort order. The artist list such as shown in FIG. 22D may be displayed.

Then, if one artist is selected by the user from the artist list shown in FIG. 22D, then information on the selection is inputted to the playback device 1900 (S2603).

Management information on the selected artist is obtained from management information in the title management file 207. Album information is searched for from the “pointer to the album management file” included in the obtained management information, and the search results are displayed as an album list (S2604). At this time, the albums may be sorted according to a predetermined sort order and then displayed.

If one album is selected by the user from the album list, then information on the selection is inputted to the playback device 1900 (S2605).

Management information on the selected album is obtained from management information in the title management file 207 and the obtained results are displayed as a title list (S2606). At this time, the titles may be sorted according to a predetermined sort order and then displayed.

If one title is selected by the user from the title list, then information on the selection is inputted to the playback device 1900 (S2607).

Based on the “pointer to the content recording location” registered in management information in the title management file 207 for the selected title, content data is obtained (S2608). Thereafter, the obtained content data is subjected to decryption and decompression processes and then reproduced.

As such, for the navigation files of the present embodiment, each management file can be searched through on the basis of the title management file 207. With this configuration, addition or deletion of an attribute management file itself can be more easily and flexibly handled over the configuration in the second embodiment.

Next, an update process for each attribute management file for the case in which content is deleted will be described with reference to FIG. 35. The process is performed by a data recording unit 1601 of a recording device 1600.

If content to be deleted is specified by the user, then data on the specified content is deleted from a recording medium 100 (S321). The content key for the content is also deleted together with the content. In each of the attribute management files 201c, 203c, . . . , for the content, the reference count in management information related to the deleted content is counted down (S322). In each of the attribute management files 201c, 203c, . . . , it is determined whether the value of the counted down reference count is 0. If the value is 0, then the management information is deleted (S323). Here, the deletion of management information refers to a process of clearing all information other than “other information” in the management information and changing the value of the other information (management information usage status) from “used” to “unused”. Note that when management information is deleted in the aforementioned step, information on pointers to relevant management information is also deleted from the sort information management file 209.

By referring to a reference count in the above-described manner, management information on attributes that becomes unnecessary with the deletion of content can be easily recognized and deleted.

### Fourth Embodiment

A fourth embodiment of the present invention will be described below. The present embodiment is different from the first, second, and third embodiments in the configuration of a sort information management file. Other configuration and operation are the same basically.

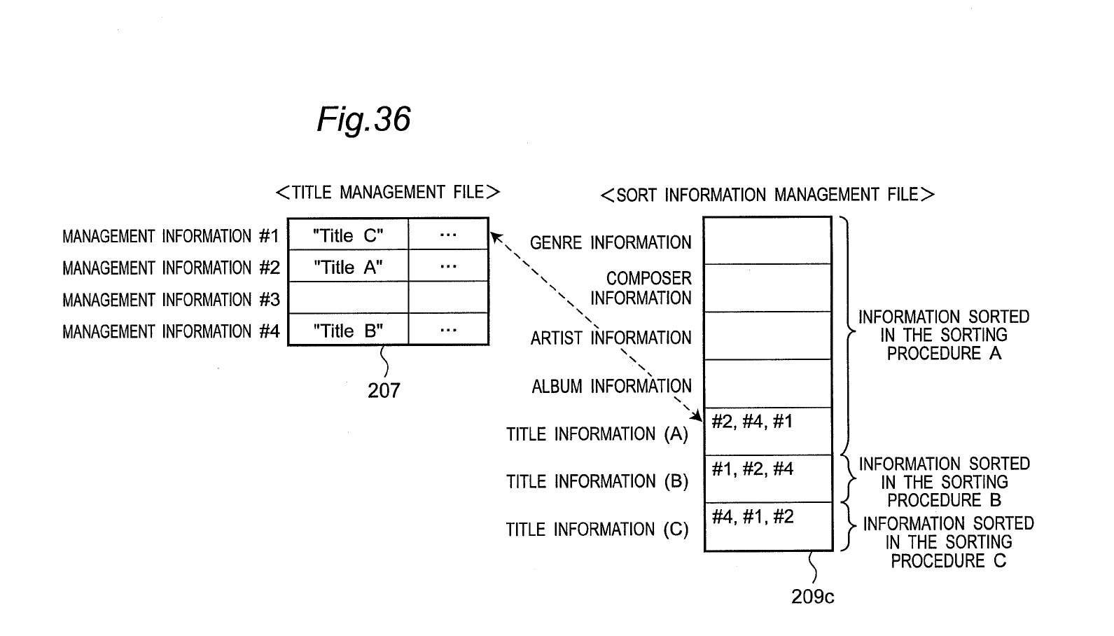

FIG. 36 is a diagram showing an exemplary configuration of a sort information management file in the present embodiment. The sort information management file 209 in the first, second, and third embodiments stores sort information for the case in which sorting is performed by only one procedure. On the other hand, in the present embodiment, a sort information management file 209c stores sort information for each procedure in a plurality of sorting procedures.

It is assumed that a sorting procedure A is a procedure in which sorting is performed alphabetically and a sorting procedure B is a procedure in which sorting is performed by date of title. Sort information for the case in which a title management file 207 is sorted by the sorting procedure A is recorded in title information (A) in a manner such as #2, #4, and #1, as shown in FIG. 36. Sort information for the case in which the title management file 207 is sorted by the sorting procedure B is recorded in title information (B) in a manner such as #1, #2, and #4. To manage sort information by another sorting procedure C, it is also possible to record sort information in title information (C) in a manner such as #4, #1, and #2.

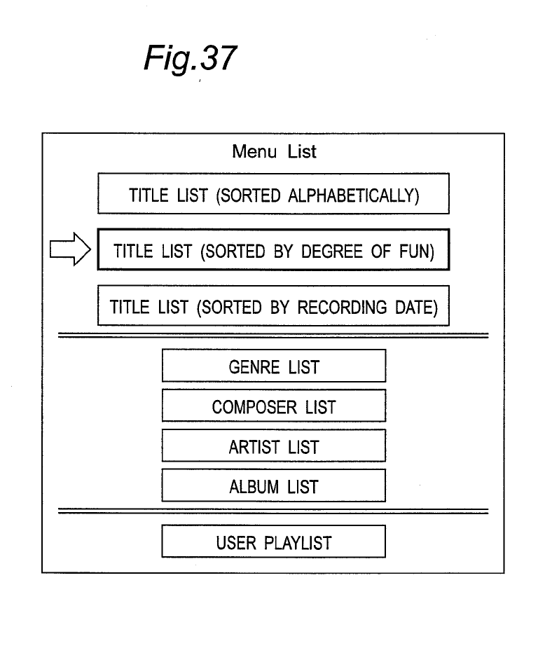

For example, an exemplary display of a playback device for the case in which such sort information is used is shown in FIG. 37. When the titles are sorted alphabetically, chronologically, and in order of degree of fun of song and managed in the sort information management file 209c, it is also possible to display lists of titles according to the types of sorting procedures as shown in FIG. 37, allowing the user to make a selection.

As such, by managing states in which sorting is performed in a plurality of procedures, a playback device can increase variation in terms of displaying content information.

Note that although the aforementioned example shows a configuration in which sort information by three sorting procedures can be managed for the title management file 207, the number and type of sorting procedures are not limited thereto. A sorting procedure and information indicating whether information according to the procedure is recorded or not may be managed, so that the sorting procedure and the information according to the procedure can be relatively freely expanded. Namely, each pieces of information on genre, composer, artist, album, and title may be sorted by different procedure so that there are plural sorting statuses. Alternatively, a configuration may be such that the pieces of sorted information are managed as different files.

### Variation

Although the concepts of the present invention have been described based on the first to fourth embodiments, needless to say, the concepts of the present invention are not limited to the above-described specific embodiments. Various changes and modifications can be made without departing from the sprit and scope of the present invention. For example, the following variant is also included in the scope of the present invention throughout the first to third embodiments.

(1) In the above-described embodiments, a semiconductor recording medium is described as an example of a medium for recording content and navigation files. However, needless to say, the concepts of the present invention can also be applied to the other recording medium (e.g., hard disk and optical disk such as DVD and CD) different from the semiconductor recording medium. A recording device or a playback device may incorporate therein a recording medium (e.g., a hard disk or semiconductor recording medium) for storing content, and record navigation files in the incorporated recording medium.

(2) Although in the above-described embodiments a FAT file system is used as a file system, other file systems such as FAT32 and UDF may be used. A data size, recording address, and so on may be managed without using a file system.

(3) Although in the above-described embodiments a key that encrypts a content key is a medium unique key, the present invention is not limited thereto. A content key can be recorded freely regardless of format. Similarly, content can also be recorded freely regardless of format. For example, if security can be secured by other methods, a plaintext content key which is not encrypted may be recorded. If there is no need to encrypt and mange content, plaintext content data may be recorded as it is without using a content key.

(4) In the above-described embodiments, information managed by navigation files include information (genre, composer, artist, album, and title) accompanying music content and sort information for each attribute management file. However the types of information to be managed and a link relationship between pieces of management information are not limited to the examples in the above-described embodiments. For example, it may be configured that a file with a specific name (e.g., a “lyric writer management file”) may be reserved in advance and only a predetermined apparatus can generate the file with a specific name. The types of information to be managed are not limited to those described above. The types of information to be managed may be changed according to the type of content data. For example, content data which is not music data may be managed by the other accompanying information.

(5) In the above-described embodiments, navigation files are composed of management files for attribute information associated with each piece of content, such as genre and composer, and a sort information management file that manages sort information on each piece of management information in the management files. The present invention is not limited to this configuration. It may be configured that a sort information management file is not included.

(6) The above-described embodiments show an example of the configuration of navigation files and a content file in a semiconductor recording medium. Thus, configuration, numbers, and names of folders and files are not limited to those in the above-described example. The configuration, and so on of folders and files can be determined freely as long as effective management of various information accompanying content and effective narrowing-down search of content can be achieved.

(7) The functions of the recording device and the playback device in the above-described embodiments may be implemented by a predetermined control program to be executed by a CPU, MPU, or the like.

Please note that the application of the present invention is related to Japanese Patent Application No. 2005-251154 (filed on Aug. 31, 2005), the content of which is incorporated herein by reference.

### INDUSTRIAL APPLICABILITY

The present invention is effective for a content data management method in which music data (audio content) encrypted for copyright protection is recorded together with a key thereto in a semiconductor recording medium. Particularly, according to the present invention, a narrowing-down search function for selecting content recorded in a recording medium can be implemented with a simple configuration. Accordingly, the present invention is useful for a playback device for content recorded in a recording medium.

1. A recording medium for storing content, comprising:
plural pieces of attribute management information, each piece of attribute management information managing each of various pieces of attribute information on the content for each of various predetermined items; and
sort management information that manages information on sort order when the information managed by the attribute management information is sorted by a predetermined procedure, wherein
the attribute management information includes text data indicating an item to be managed thereby, and pointer information indicating a link relationship between pieces of attribute management information, and
the sort management information includes, for each piece of attribute management information, information on a sort order when all entries in each piece of attribute management information are sorted by a predetermined procedure, being composed of pointer information to the sorted entries of the attribute management information.

2. The recording medium according to claim 1, wherein the pieces of attribute management information include a plurality of management files and the plurality of management files are hierarchically linked to one another.

3. The recording medium according to claim 1, wherein the sort management information includes, for each of a plurality of sorting procedures, information on sort order obtained after sorting, when the entries in each piece of attribute management information are sorted by the plurality of sorting procedures.

4. The recording medium according to claim 1, wherein the sorting is performed based on the text data.

5. The recording medium according to claim 1, wherein the sorting is performed based on time information.

6. The recording medium according to claim 1, wherein the sorting is performed based on a characteristic of the content.

7. The recording medium according to claim 1, wherein the attribute management information and/or the sort management information are/is variable in size according to an amount of information to be managed by the attribute management information and/or the sort management information.

8. The recording medium according to claim 1, wherein flag information is stored in each entry of the attribute management information, indicating that the entry is “used” or “unused”.

9. The recording medium according to claim 8, wherein the flag information is variable in size according to an amount of information to be managed.

10. The recording medium according to claim 1, wherein the content includes audio content and the predetermined item includes at least one of genre, composer, artist, album, and title.

11. A recording device for recording content in a recording medium, comprising:
an input unit that inputs content and pieces of various attribute information on the content; and
a data recording unit that records the inputted content to the recording medium, wherein
the data recording unit
generates pieces of attribute management information and sort management information based on the attribute information inputted from the input unit, each piece of attribute management information managing each of various pieces of attribute information on the content for each of various predetermined items, the sort management information managing information on sort order when the information managed by the attribute management information is sorted by a predetermined procedure and being composed of pointer information to the sorted entries of the attribute management information, and
records the generated attribute management information and sort management information together with the content to the recording medium.

12. A playback device for reproducing content stored in a recording medium, wherein
(a) the recording medium stores
plural pieces of attribute management information, each piece of attribute management information managing each of various pieces of attribute information on the content for each of various predetermined items, and
sort management information that manages information on sort order when the information managed by the attribute management information is sorted by a predetermined procedure,
the attribute management information includes text data indicating an item to be managed thereby, and pointer information indicating a link relationship between pieces of attribute management information, and
the sort management information includes, for each piece of attribute management information, information on a sort order when all entries in each piece of attribute management information are sorted by a predetermined procedure, being composed of pointer information to the sorted entries of the attribute management information, and
(b) the playback device comprises a content reader that reads out the attribute management information and the sort management information from the recording medium and identifies desired content data according to a user selection by referring to the read attribute management information and sort management information.

13. The playback device according to claim 12, further comprising a display unit that displays information sorted by referring to the sort management information.

14. The playback device according to claim 12, which incorporates the recording medium therein.

15. A computer readable recording medium that stores a program for recording content in a recording medium, the program causing a computer to execute the procedures of:
inputting content and pieces of various attribute information on the content;
generating pieces of attribute management information and sort management information based on the inputted attribute information, each piece of attribute management information managing each of various pieces of attribute information on the content for each of various predetermined items, the sort management information managing information on sort order when the information managed by the attribute management information is sorted by a predetermined procedure and being composed of pointer information to the sorted entries of the attribute management information; and
recording the generated attribute management information and sort management information together with the content to a recording medium.

16. A computer readable recording medium that stores a program for reproducing content from a recording medium, wherein
(a) the recording medium stores
plural pieces of attribute management information, each piece of attribute management information managing each of various pieces of attribute information on the content for each of various predetermined items, and
sort management information that manages information on sort order when the information managed by the attribute management information is sorted by a predetermined procedure,
the attribute management information includes text data indicating an item to be managed thereby, and pointer information indicating a link relationship between pieces of attribute management information, and
the sort management information includes, for each piece of attribute management information, information on a sort order when all entries in each piece of attribute management information are sorted by a predetermined procedure, being composed of pointer information to the sorted entries of the attribute management information, and
(b) the program causes a computer to execute the procedures of:
reading out the attribute management information and the sort management information from the recording medium;
sorting the information managed by each piece of attribute management information according to the sort management information, and displaying the sorted information on a selection screen; and
identifying content to be reproduced, according to information selected by a user on the selection screen.
